(19) United States
(12) Patent Application Publication
(10) Pub. No.: US 2005/0238913 A1
(43) Pub. Date: Oct. 27, 2005

(54) Luminescent material compositions, devices and methods of using

(76) Inventors: Stephen M. Kelly, Beverley (GB); Gene C. Koch, Bayville, NJ (US)

Correspondence Address: Ronald D. Trice;PMB 138, 2101 Crystal Plaza Arcade, Arlington, VA, 22202-4600, US

(21) Appl. No.: 11/006,807

(22) Filed: Dec. 8, 2004

Related U.S. Application Data
(60) Provisional application No. 60/527,825, filed on Dec. 9, 2003.

(51) Int. Cl. B32B 19/00

(52) U.S. Cl. 428/690

(57) ABSTRACT

Dopants having a liquid crystalline phase and hosts incorporating the dopants are disclosed. The dopants may be used with liquid crystalline hosts, polymeric hosts and other hosts. The host may be selected to have an emission band that overlaps the maximum of the excitation band of the dopant and the dopant may have an emission spectrum peak that is substantially unabsorbed by the host. When the dopant is aligned, the light emitted by the dopant will be polarized. The dopants may have a room temperature nematic phase. The host and dopants form excellent emitter layers.

### RELATED APPLICATIONS

This application claims priority from, and incorporates by reference, U.S. Provisional application Ser. No. 60/527,825, filed Dec. 9, 2003.

### FIELD OF THE INVENTION

The present invention relates generally to emissive dopant materials, devices and methods and more particularly, to electroluminescent dopant materials, devices and methods having advantageous properties such as improved quantum efficiency in organic light emitting devices.

### BACKGROUND

The suitability and/or desirability of a material or combination of materials for a particular application are dependent upon its properties. With emissive devices, one such property is the quantum efficiency of the emissive material or combination of materials that emit light. However, properties other quantum efficiency may affect this suitability and/or desirability. For example, the material or combination of materials must be reasonably useable with the other materials or other device structures with which it is to be combined. However, the creation of such material or materials and/or their combination with other materials is difficult. According, there is a need in the art for emissive material or combination of materials having improved quantum efficiency or other advantageous properties.

### SUMMARY OF THE INVENTION

An aspect of the present invention is to provide a compound including an emissive dopant having a liquid crystalline phase.

Another aspect of the present invention is to provide a method of using a compound including doping a host with an emissive dopant having a liquid crystalline phase.

Another aspect of the present invention is to provide an emissive layer including a host doped with an emissive dopant having a liquid crystalline phase.

Another aspect of the present invention is to provide a method of generating light including exciting a first material to an electronically excited state and transferring energy of the first material in the electronically excited state to a second material such that the second material emits light. The light is polarized.

Another aspect of the present invention is to provide a charge transporting or light emitting compound including a molecule having the formula: E-S-C-L-C-S-E. The E is a reactive molecular end group that is capable of being crosslinked, S is a flexible spacer; C is a chromophoric unit that absorbs electrical, photon, or chemical energy promoting the molecule into an excited electronic state, L is a structure or structures that extend laterally from the otherwise lathe-shaped compound. The C-L-C is not fluorene.

Another aspect of the present invention is to provide a derivative charge transporting or light emitting molecule including a charge transporting or light emitting molecule having the formula: E-S-C-L-C-S-E. The E is a reactive molecular end group that is capable of being crosslinked, S is a flexible spacer; C is a laser dye or laser dye structure, L is a structure or structures that extend laterally from the otherwise lathe-shaped compound.

Another aspect of the present invention is to provide a charge transporting or light emitting molecule including a charge transporting or light emitting molecule having the formula: 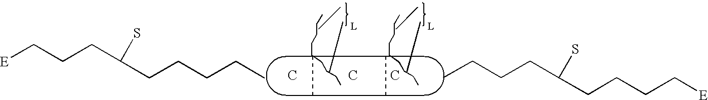
The E is a reactive molecular end group that is capable of being crosslinked, S is a flexible spacer; C is a laser dye or laser dye structure, L is a structure or structures that extend laterally from the otherwise lathe-shaped compound.

Another aspect of the present invention is to provide an emitter molecule including a molecule selected from one of the following group:

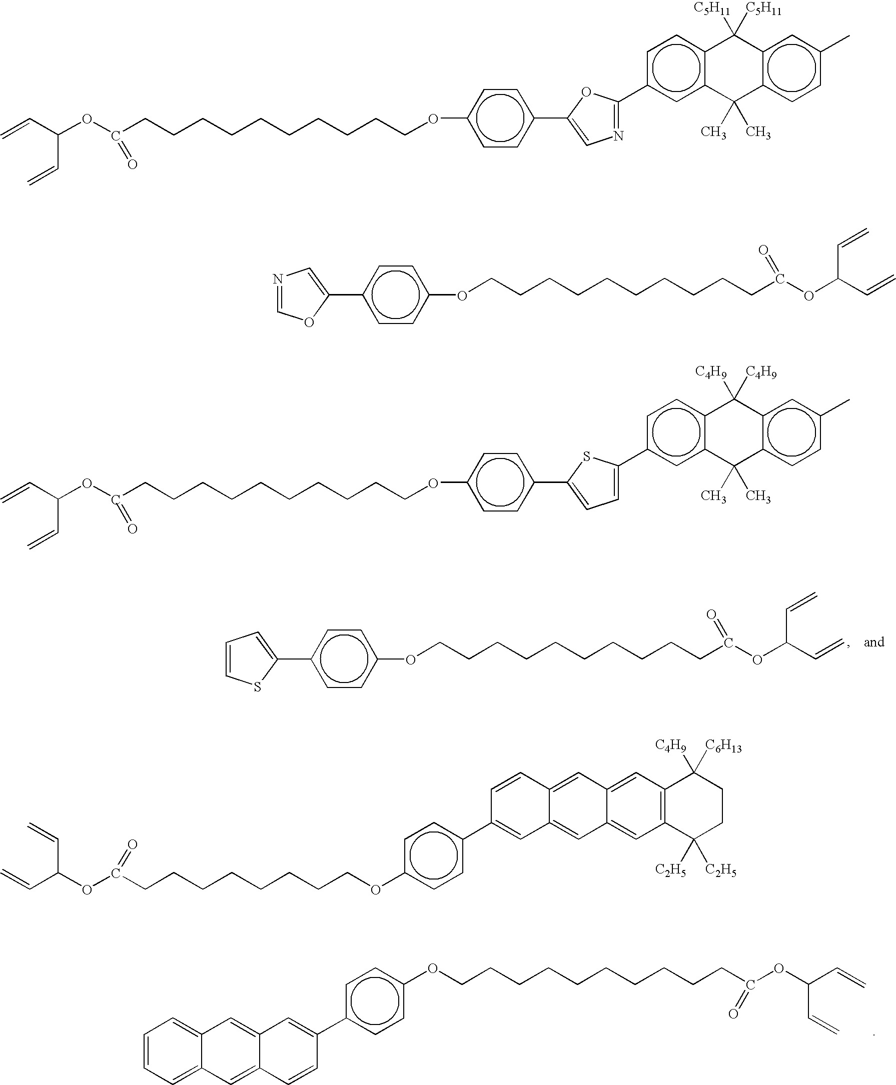

Another aspect of the present invention is to provide an organometallic emitter molecule including an emitter molecule having the formula selected from one of: 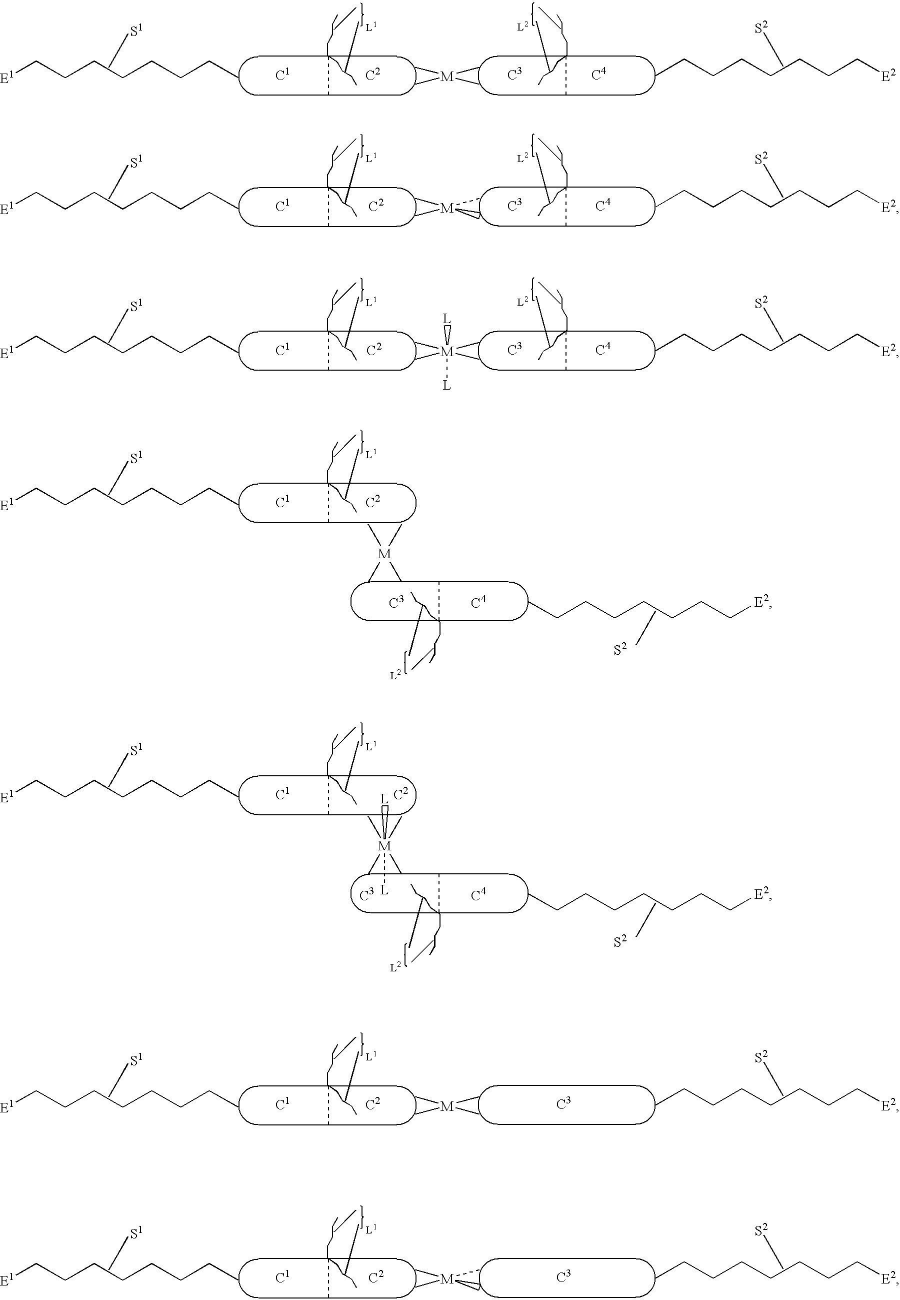 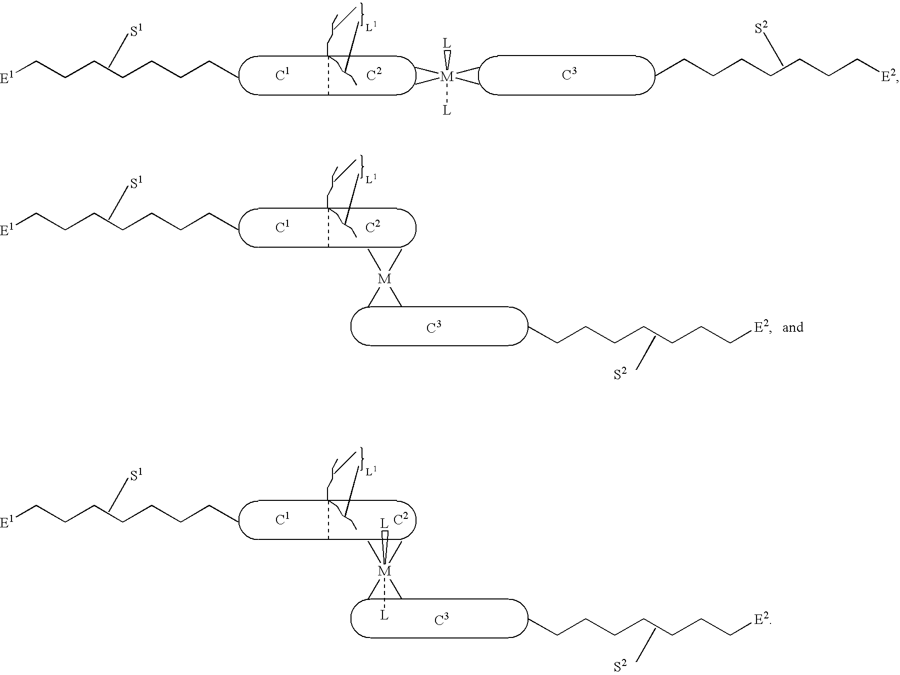
The E¹, E² are reactive molecular end groups that are capable of being crosslinked, S¹ and S² are flexible spacers; C¹, C², C³ and C⁴ are chromophoric units that absorbs electrical, photon, or chemical energy and then reradiates the electrical, photon, or chemical energy as light or laser dyes, L¹, L², L³, L⁴ is a structure or structures that extend laterally from the otherwise lathe-shaped compound, L is monodentate ligand and M is a metal atom.

Another aspect of the present invention is to provide a method of generating light including exciting a first material to an electronically excited state and transferring energy of the first material in the electronically excited state to a second material such that the second material emits light. The second material has a liquid crystalline phase.

Another aspect of the present invention is to provide an emissive layer including a host doped with an emissive dopant having molecules that are rod or lathe-shaped.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 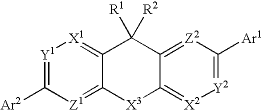
where X¹, Y¹, Z¹, X², Y², and Z² may be independently chosen from N or CH; X³ is chosen from O, NR³, CR³R⁴, S, PR³, SiR³R⁴ or carbonyl, where R³ and R⁴ may be independently chosen from H, linear alky, branched alkyl or alkenyl chains; R¹ and R² are flexible side chains selected from the group consisting of linear alkyl, branched alkyl, and alkenyl chains optionally including heteroatoms, carboxyl linkages and may optionally be terminated by a diene functional group chosen from amongst 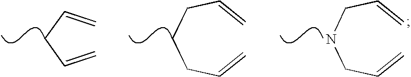
and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 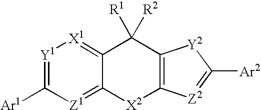
wherein X¹, Y¹ and Z¹ may be independently chosen from N or CH; X² is chosen from O, NR³, CR³R⁴, S, PR³, SiR³R⁴, or carbonyl, where R³ and R⁴ may be independently chosen from H, linear alky, branched alkyl or alkenyl chains; R¹ and R² are flexible side chains selected from the group consisting of linear alkyl, branched alkyl, and alkenyl chains optionally including heteroatoms, carboxyl linkages and may optionally be terminated by a diene functional group chosen from amongst 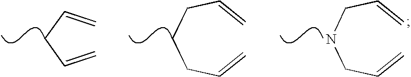
Y² may be chosen from O, S, or NH; Z² may be chosen from CH or N; and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 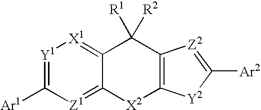
wherein X¹, Y¹ and Z¹ may be independently chosen from N or CH; X² is chosen from O, NR³, CR³R⁴, S, PR³, SiR³R⁴, or carbonyl, where R³ and R⁴ may be independently chosen from H, linear alky, branched alkyl or alkenyl chains; R¹ and R² are flexible side chains selected from the group consisting of linear alkyl, branched alkyl, and alkenyl chains optionally including heteroatoms, carboxyl linkages and may optionally be terminated by a diene functional group chosen from amongst 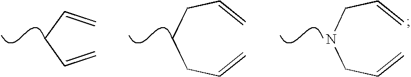
Y² may be independently chosen from O, S, or NH; Z² may be chosen from CH or N; and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 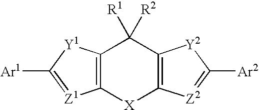
wherein X is chosen from O, NR³, CR³R⁴, S, PR³, SiR³R⁴, or carbonyl, where R³ and R⁴ may be independently chosen from H, linear alky, branched alkyl or alkenyl chains; R¹ and R² are flexible side chains selected from the group consisting of linear alkyl, branched alkyl, and alkenyl chains optionally including heteroatoms, carboxyl linkages and may optionally be terminated by a diene functional group chosen from amongst 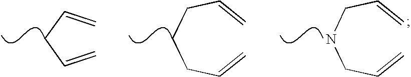
Y¹ and Y² may be independently chosen from O, S, or NH; Z¹ and Z² may be independently chosen from CH or N; and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 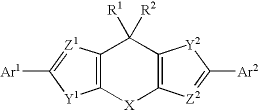
wherein X is chosen from O, NR³, CR³R⁴, S, PR³ SiR³R⁴, or carbonyl, where R³ and R⁴ may be independently chosen from H, linear alky, branched alkyl or alkenyl chains; R¹ and R² are flexible side chains selected from the group consisting of linear alkyl, branched alkyl, and alkenyl chains optionally including heteroatoms, carboxyl linkages and may optionally be terminated by a diene functional group chosen from amongst 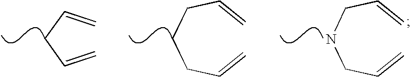
Y¹ and Y² may be independently chosen from O, S, or NH; Z¹ and Z² may be independently chosen from CH or N; and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 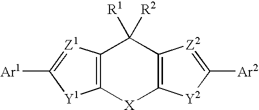
wherein X is chosen from O, NR³, CR³R⁴, S, PR³, SiR³R⁴, or carbonyl, where R³ and R⁴ may be independently chosen from H, linear alky, branched alkyl or alkenyl chains; R¹ and R² are flexible side chains selected from the group consisting of linear alkyl, branched alkyl, and alkenyl chains optionally including heteroatoms, carboxyl linkages and may optionally be terminated by a diene functional group chosen from amongst 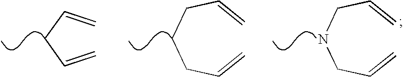
Y¹ and Y² may be independently chosen from O, S, or NH; Z¹ and Z² may be independently chosen from CH or N; and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 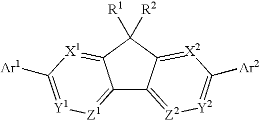
wherein five of X¹, Y¹, Z¹, X², Y², and Z² may be independently chosen from N or CH provided the sixth of X¹, Y¹, Z¹, X², Y², and Z² is CH; R¹ and R² are flexible side chains selected from the group consisting of linear alkyl, branched alkyl, and alkenyl chains optionally including heteroatoms, carboxyl linkages and may optionally be terminated by a diene functional group chosen from amongst 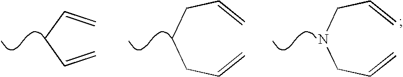
and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 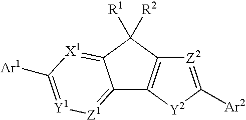
wherein X¹, Y¹, and Z¹ may be independently chosen from N or CH; R¹ and R² are flexible side chains selected from the group consisting of linear alkyl, branched alkyl, and alkenyl chains optionally including heteroatoms, carboxyl linkages and may optionally be terminated by a diene functional group chosen from amongst 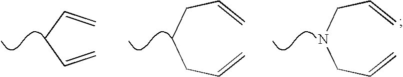
Y² may be chosen from O, S, or NH; Z² may be chosen from CH or N; and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 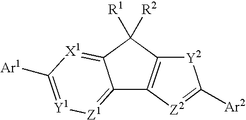
wherein X¹, Y¹, and Z¹ may be independently chosen from N or CH; R¹ and R² are flexible side chains selected from the group consisting of linear alkyl, branched alkyl, and alkenyl chains optionally including heteroatoms, carboxyl linkages and may optionally be terminated by a diene functional group chosen from amongst 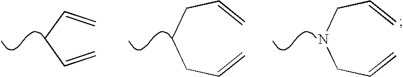
Y² may be chosen from O, S, or NH; Z² may be chosen from CH or N; and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 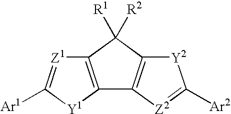
wherein R¹ and R² are flexible side chains selected from the group consisting of linear alkyl, branched alkyl, and alkenyl chains optionally including heteroatoms, carboxyl linkages and may optionally be terminated by a diene functional group chosen from amongst 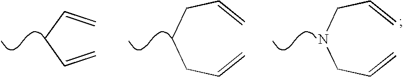
Y¹ and Y² may be independently chosen from O, S, or NH; Z¹ and Z² may be independently chosen from CH or N; and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 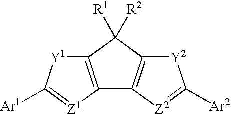
wherein R¹ and R² are flexible side chains selected from the group consisting of linear alkyl, branched alkyl, and alkenyl chains optionally including heteroatoms, carboxyl linkages and may optionally be terminated by a diene functional group chosen from amongst 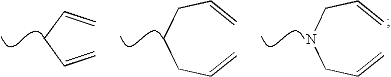
Y¹ and Y² may be independently chosen from O, S, or NH; Z¹ and Z² may be independently chosen from CH or N; and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 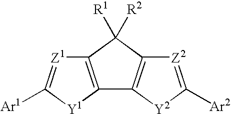
wherein R¹ and R² are flexible side chains selected from the group consisting of linear alkyl, branched alkyl, and alkenyl chains optionally including heteroatoms, carboxyl linkages and may optionally be terminated by a diene functional group chosen from amongst 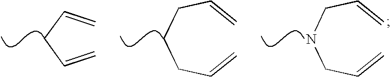
Y¹ and Y² may be independently chosen from O, S, or NH; Z¹ and Z² may be independently chosen from CH or N; and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 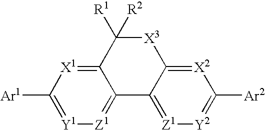
wherein X¹, Y¹, Z¹, X², Y², and Z² may be independently chosen from N or CH; X³ is chosen from O, NR³, CR³R⁴, S, PR³, SiR³R⁴ or carbonyl, where R³ and R⁴ may be independently chosen from H, linear alky, branched alkyl or alkenyl chains; R¹ and R² are flexible side chains selected from the group consisting of linear alkyl, branched alkyl, and alkenyl chains optionally including heteroatoms, carboxyl linkages and may optionally be terminated by a diene functional group chosen from amongst 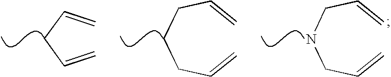
and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 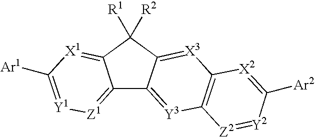
wherein X¹, Y¹, Z¹, X², Y², Z², X³, and Y³ may be independently chosen from N or CH; R¹ and R² are flexible side chains selected from the group consisting of linear alkyl, branched alkyl, and alkenyl chains optionally including heteroatoms, carboxyl linkages and may optionally be terminated by a diene functional group chosen from amongst 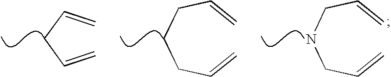
and wherein Ar¹ and Ar² may independently be may be one or more aryl groups chained together in a substantially linear fashion.

Another aspect of the present invention is to provide charge transporting or light emitting compound including a molecule having the formula: E-S-CLC-S-E where E is a reactive molecular end group that is capable of being crosslinked, S is a flexible spacer and the CLC is a molecular core of the general formula: 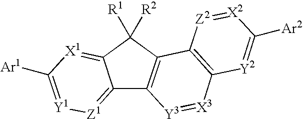
wherein X¹, Y¹, Z¹, X², Y², Z², X³, and Y³ may be independently chosen from N or CH; R¹ and R² are flexible side chains selected from the group consisting of linear alkyl, branched alkyl, and alkenyl chains optionally including heteroatoms, carboxyl linkages and may optionally be terminated by a diene functional group chosen from amongst 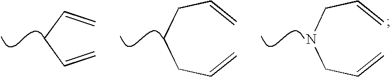
and wherein Ar¹ and Ar² may independently be may be one or more aryl groups chained together in a substantially linear fashion.

### BRIEF DESCRIPTION OF THE DRAWINGS

The invention will be described in detail with reference to the following drawings in which like reference numerals refer to like elements wherein:

FIG. 1 illustrates the emission spectrum and the absorption spectrum of GJR130 and coumarin 6; and

FIG. 2 illustrates the absorbance and luminescence spectra of PV228 and MPA290.

### DESCRIPTION

Exemplary embodiments of the present invention include, but are not limited to, doping a host with an electroluminescent dopant. The host may be a liquid crystalline organic charge transporting material or an organic material lacking a liquid crystalline phase, and the dopant may be a liquid crystalline organic luminescent material or an organic material lacking a liquid crystalline phase, or any other suitable dopant material or materials. The dopant and host may be combined to form an emitter in an organic light emitting device (OLED).

This kind of an emitter composition is advantageous in several ways. First, the dopant concentration may be relatively small and yield efficient conversion of electrical energy into light in the dopant electroluminescent emission band. Dopant concentrations of less than about 25%, very often less than 10%, and often less than about 5% yield OLEDs of excellent luminous efficacy. The dopant concentrations are advantageous because that total light absorption by the dopant in its spectral emission band of wavelengths is proportional by Beer's law to its concentration in the emitter layer. A dopant concentration of 5% in the emitter layer, therefore, means a loss by self-absorption of only 5% of that in an emitter layer containing 100% of the dopant material.

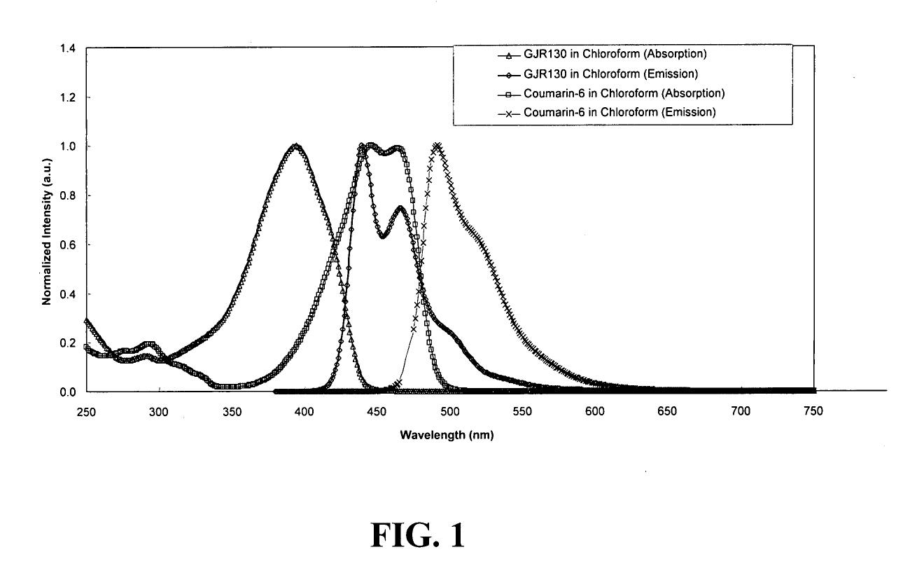

FIG. 1 illustrates the emission spectrum and the absorption spectrum of GJR130 and coumarin 6. The GJR130 is doped with 5% by weight of the laser dye coumarin 6. As illustrated in FIG. 1, the host material GJR130 has essentially no absorption at the peak emission band of the coumarin 6. The emission band energy of GJR130, on the other hand overlaps the absorption band of coumarin 6. Exciton energy is transferred from the from the electrically excited GJR130 molecules into the coumarin 6 molecules promoting them into an excited state. Since the molecules of the two materials coexist in the same nematic liquid crystalline lattice, energy transfer often does not occur by a radiative mechanism, but by Förster or Dexter transfer of energy.

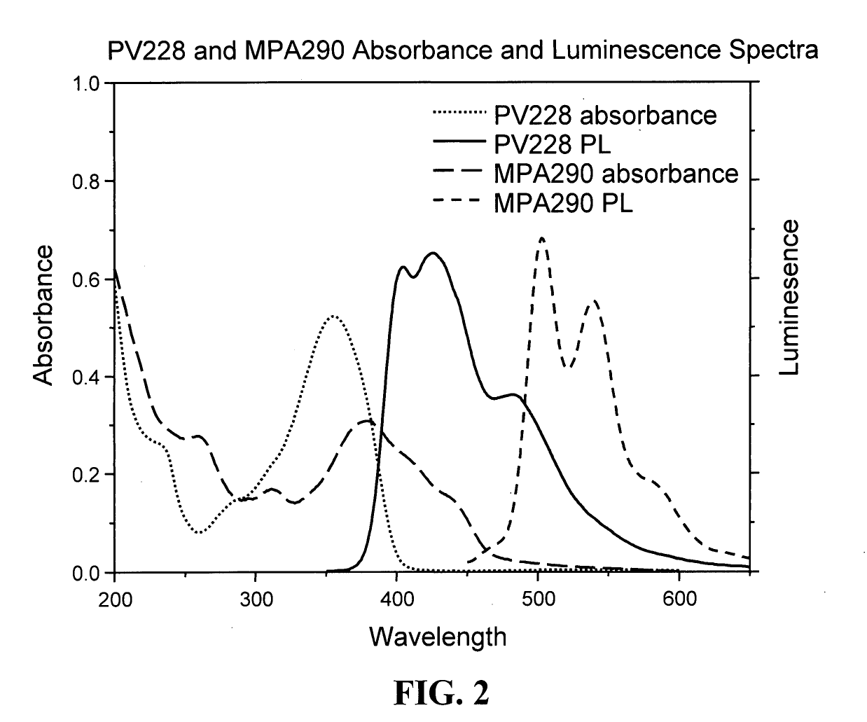

By using a liquid crystalline material as the dopant in an emitter composition, an OLED that yields polarized light emission upon electrical excitation may be fabricated. For example, the charge transporting material PV228 may be used as the host material in the emitter composition while the dopant may be a second liquid crystalline emitter MPA290. As shown in FIG. 2, which illustrates the absorbance and luminescence spectra of PV228 and MPA290, MPA290 emits between 500 and 550 nm and its excitation band overlaps the emission band of PV228. Thus, emitter layers fabricated from a composition including 95% PV228 and 5% MPA290 maybe made such that an excitation current will promote molecules in PV228 into an excited electronic state. This excitation energy then may be efficiently transferred to MPA290 by radiative or non-radiative mechanism. The MPA290 then emits 500-550 nm light. A highly efficient emitter may be fabricated using this configuration since the excitation band of the MPA290 overlaps the emission band of the PV228 and because the self-absorption of MPA290 is minimized by its dilution in PV228. The emissive layer may be aligned into a well-ordered nematic phase and crosslinked by exposure to UV radiation. The resulting aligned emitter layer may be incorporated into an OLED or another device and will emit highly plane-polarized radiation in the range 500 to 550 nm. Alternatively, devices that emit unpolarized light may be fabricated by leaving the emissive layer unaligned or by using an isotropic dopant material (e.g. coumarin 6).

By proper selection of host and dopant materials, various OLED and other devices may be fabricated that emit light of any desired spectra (e.g., blue, green, or red light). Specifically, a host may be selected to have an emission band that overlaps the maximum of the excitation band of the dopant. For example, a common spectrum associated with excitation band of a blue emitter dopant is the shortest wavelength and therefore the highest energy range at which excitation by the host is required. Blue emitters quite often have an excitation band that peaks in the UV. Therefore, it is advantageous that the host in the emitter formulation have an emission band in the UV. Such a host may be fabricated by incorporating known UV emitting laser dye structures or very similar structures into the molecular architecture of the host material similar to GJR130, MPA290 and other suitable compounds. Alternatively, this process may be used to fabricate hosts that emit light in bands other than the UV.

An exemplary this molecular architecture is:
E-S-C-L-C-S-E
wherein each E is a reactive molecular end group that is capable of crosslinking to other molecules, for example, dienes, oxetanes, acrylates, vinyl ethers and the like; each S is a flexible spacer including multiple methylene linkages or similar flexible chains; each C is a chromophoric unit that may absorb electrical, photon, or chemical energy promoting the molecule into an excited electronic state; L consists of a structure or structures that extend(s) laterally from the otherwise lathe-shaped compound.

The reason for the inclusion of L in the molecular architecture is to spoil the lathe-like symmetry of the molecules and thereby lower the melting point of a material that would otherwise be unusably high. In many cases the two “C” units combine to form a single chromophore. An example of this architecture is the bisbiphenylfluorene compound: 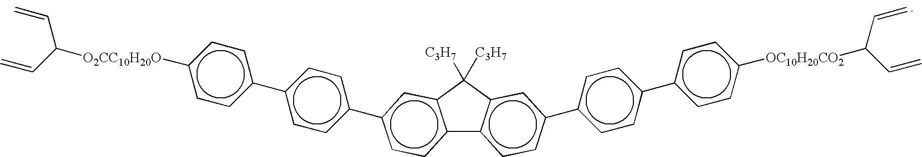
The two n-propyl groups at the 9 positions of the fluorine unit extend laterally from the lathe-shaped molecule. The fluorene linkage unites two terphenyl units (the Cs in this case) into a single sexiphenyl chromophore. However, sexiphenyl itself is an extremely high melting material. The addition of the two n-propyl groups and, to a lesser extent, the two end groups of the molecule lowers the melting point down to 143° C. This, in turn, results in the existence of a thermodynamically stable nematic phase.

Another way to represent this molecular architecture is: 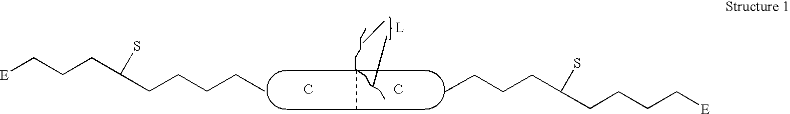
In this particular case L constitutes two alkyl groups of arbitrary length and the spacers S are also alkyl groups.

Following are some exemplary compounds in which the structures of or, at least, structures quite similar to known laser dyes are incorporated into the above molecular architecture:

### EXAMPLE 1

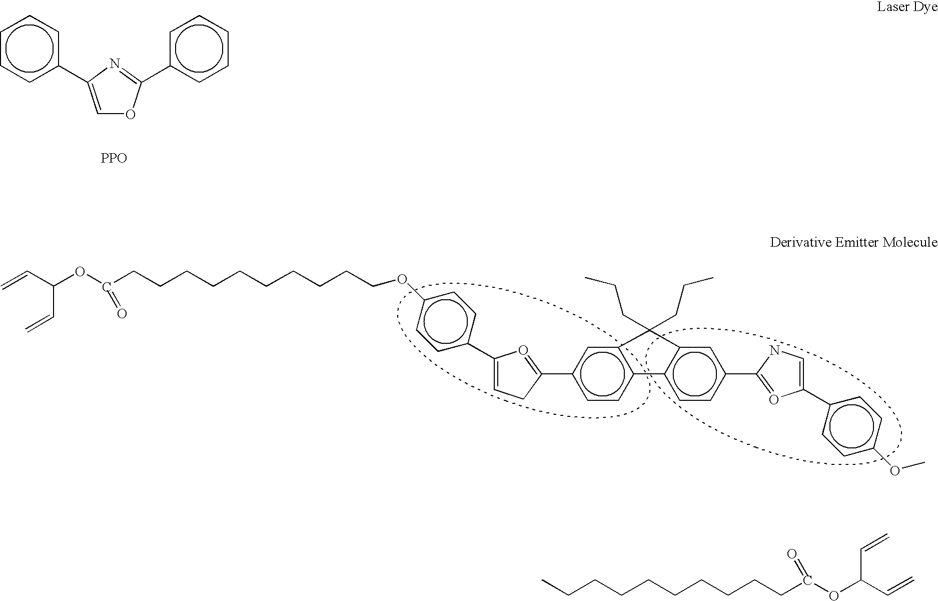

### EXAMPLE 2

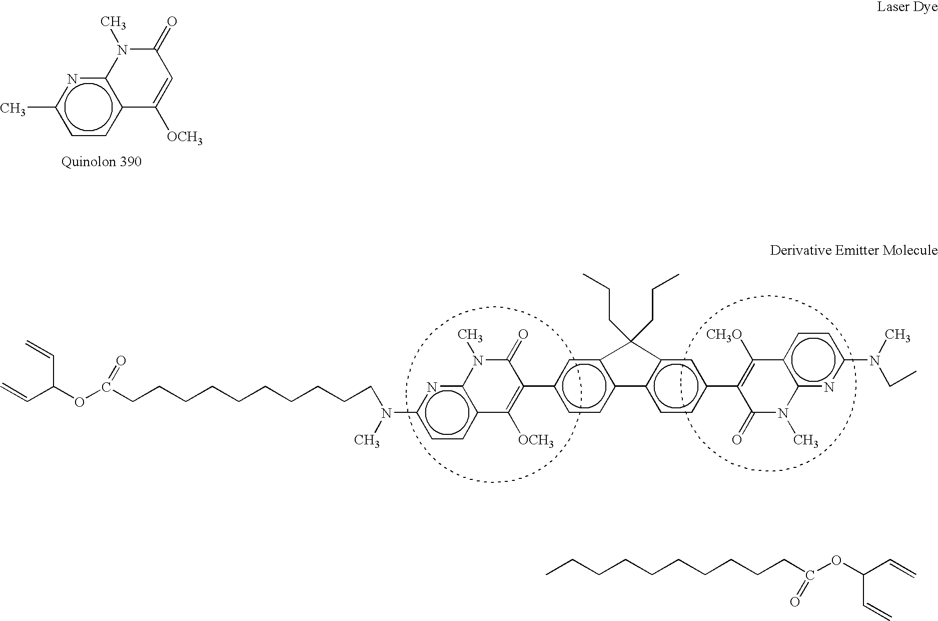

### EXAMPLE 3

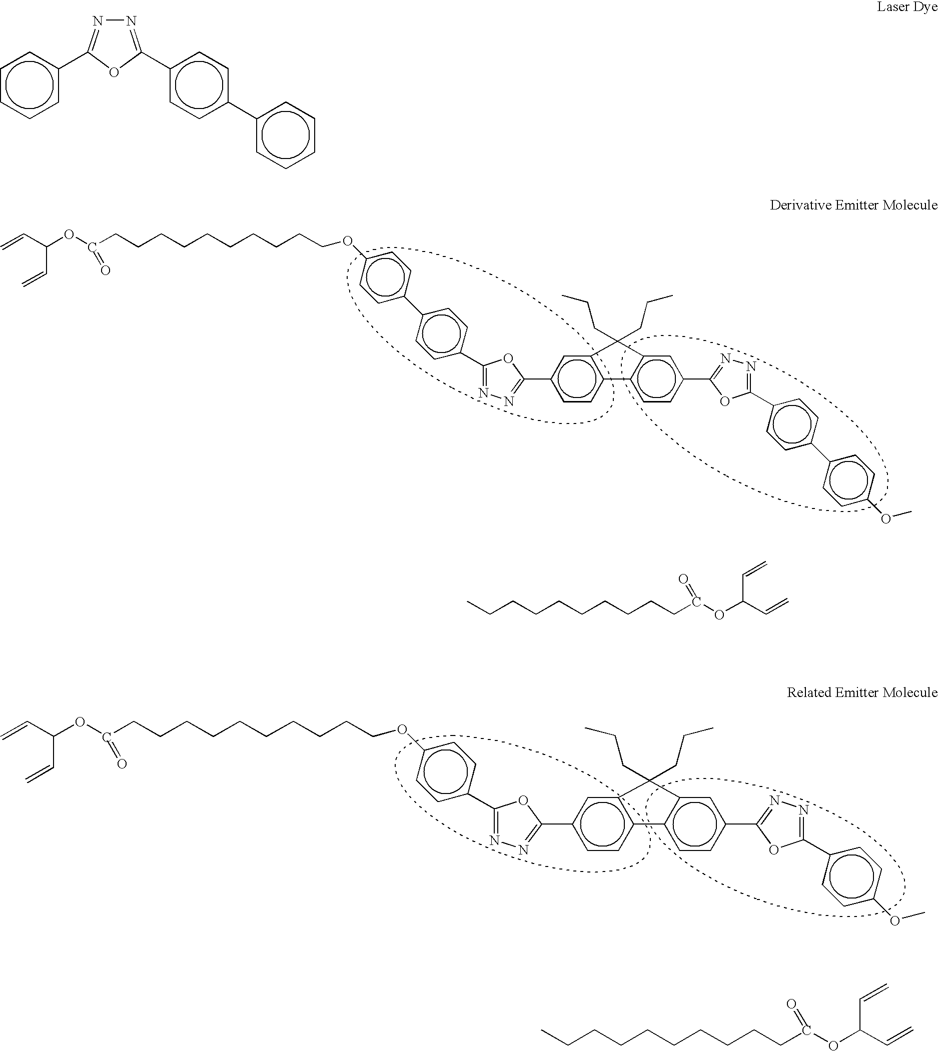

### EXAMPLE 4

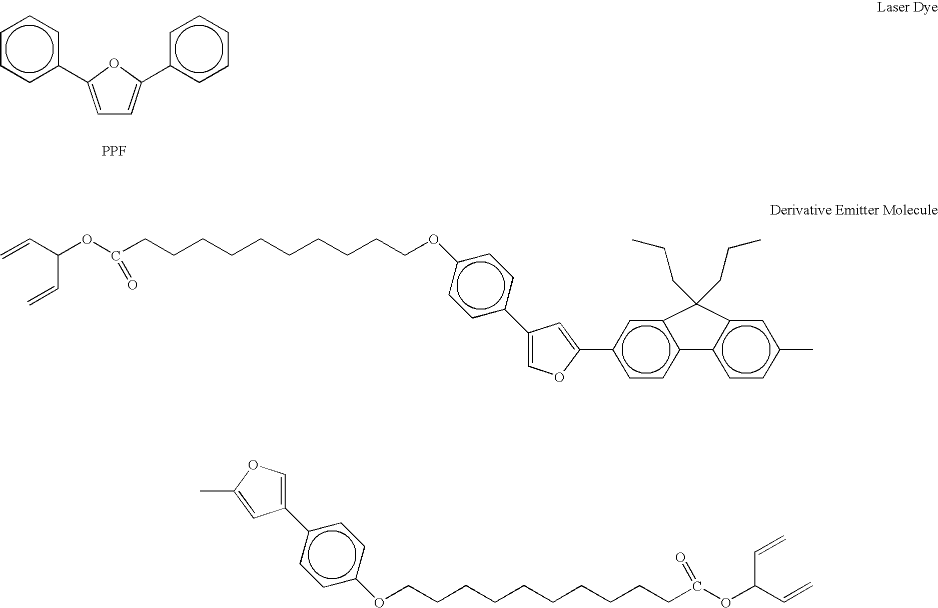

### EXAMPLE 5

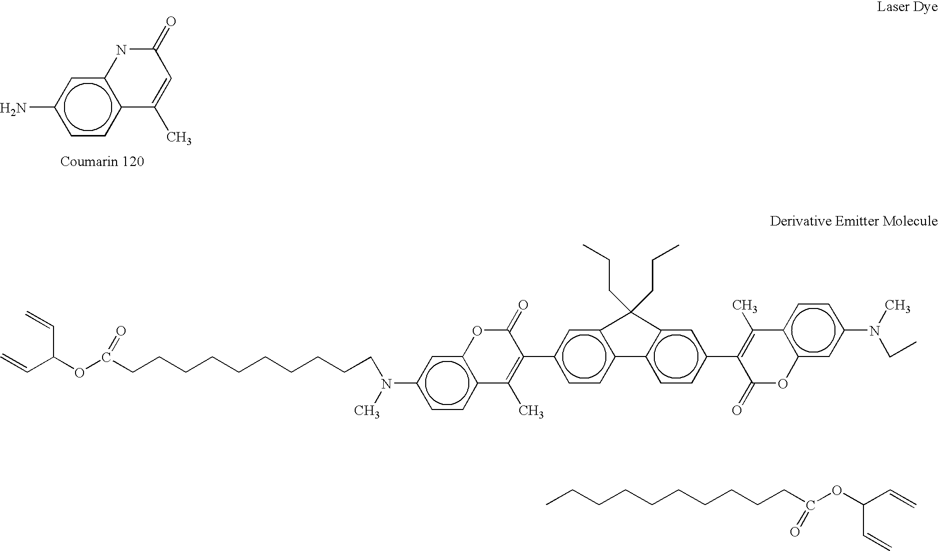

Another exemplary structure is as follows:

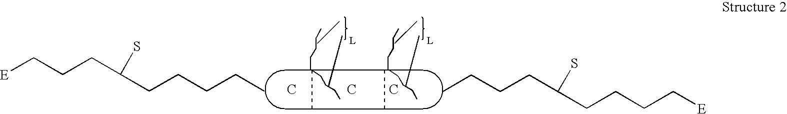

Following are shown some exemplary compounds in which the structures of or, at least, structures quite similar to known laser dyes are incorporated into the above molecular architecture:

### EXAMPLE 6

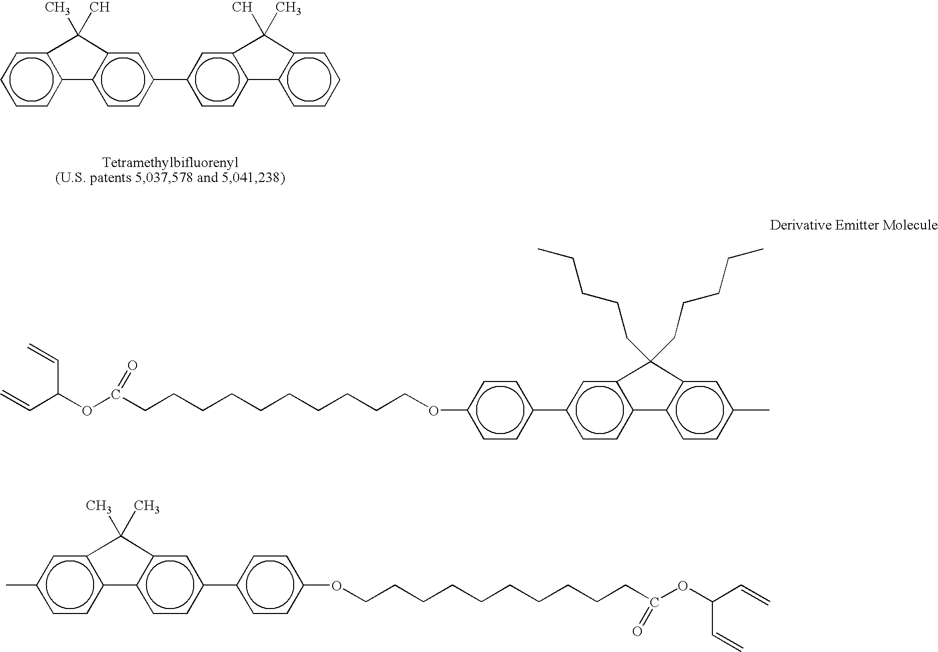 The laser dye based charge transport and emitter materials described in Examples 1-6 may be used as hosts or dopants and may be used as charge transporting and light emitting materials in OLEDs as described in U.S. patent application Ser. Nos. 10/187,381 and 10/187,402, which are incorporated herein by this reference.

In examples 1-6, the C-L-C portions of the emitter molecules have included fluorene or fluorene derivatives. Alternatively, other structures that serve the same functions may be used. For example, other structures that may constitute the C-L-C assembly are the 9,9,10,10-tetraalkyl-9,10-dihydroanthracene-2,6-diyl diradical and the 9,9-dialkyl-9,10-dihydroanthracene-2,6-diyl diradical. 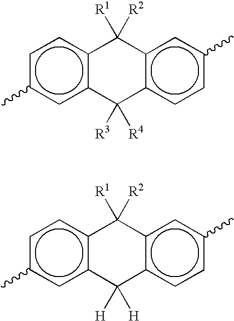
The first of these structures utilizes four L groups whereas the second utilizes only two.

Example emitter molecules containing these assemblies are as follows:

### EXAMPLE 7

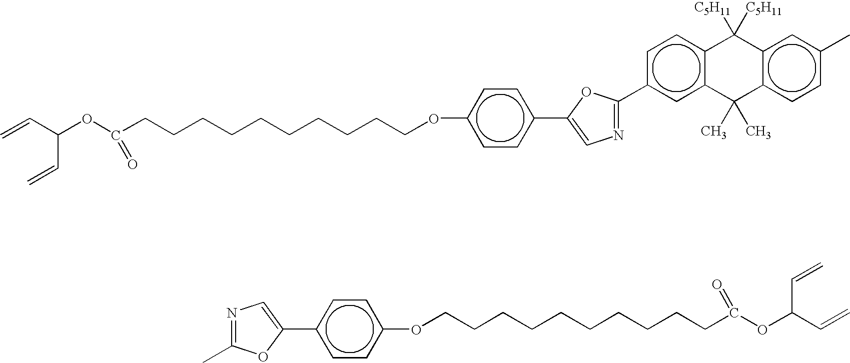

### EXAMPLE 8

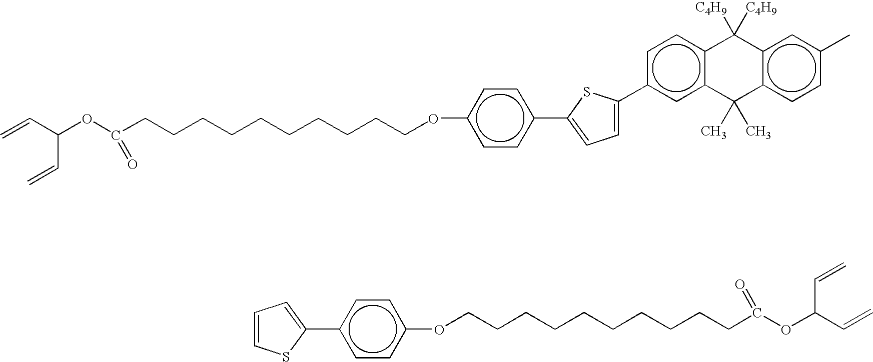

These dihydoanthracene derivatives are advantageous, in part, because substitution pattern at the 9 and 10 positions of the anthracene nucleus, or in the case of example 9 (discussed below) the equivalent positions of the acene nucleus, yields a structure in which there is no through conjugation from one side of the molecule to the other. For example, in the case of example 7 there are two isolated chromophores separated by the saturated bonding at the 9 and 10 positions each of which behaves spectrally very much like the laser dye PPO. The result is that it is possible to have a long, rigid, lathe-shaped nucleus in the molecule that encourages liquid crystalline behavior, while at the same time constraining the chromophore volume over which electron delocalization occurs thus maintaining an excited to ground state spectral transition of sufficient energy to assure light emission in the desired (e.g., UV or blue) region of the spectrum.

The dihydroanthracene derivatives are part of a larger subset of materials, the dihydroacenes with the general formula: 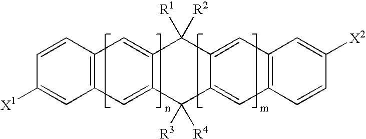
where n and m may independently vary from 0 to 5 (n=m=0 corresponds to dihydroanthracenes, X¹ and X² may independently be one or more aryl groups chained together in a substantially linear fashion and then terminated with a flexible spacer of the type described above that is in turn terminated with a diene crosslinking functional group chosen from amongst: 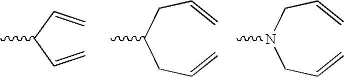
or other crosslinking functional groups or X¹ and X² may be a flexible spacer of the type described above that is terminated with a diene or other crosslinking functional group, and R¹, R², R³, and R⁴ may be flexible side chains selected from the group consisting of linear alkyl, branched alkyl, and alkenyl chains optionally including heteroatoms, carboxyl linkages and may optionally be terminated by a diene functional group chosen from amongst

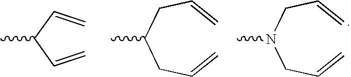

An example of such a dihydroacene compound is:

### EXAMPLE 9

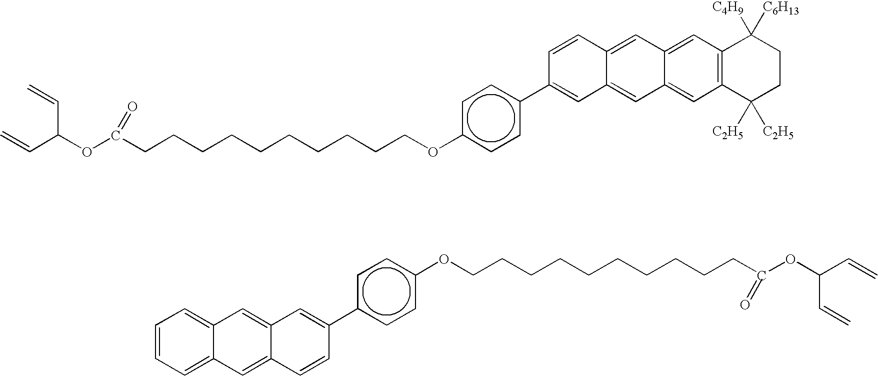 The dihyroanthracene compounds and more generally the dihydroacene compounds described above may be used as hosts or and may be used as charge transporting and light emitting materials in OLEDs as described in U.S. patent application Ser. Nos. 10/187,381 and 10/187,402.

Alternatively, other molecular core units yielding the E-S-C-L-C-S-E architecture may be used. For example: 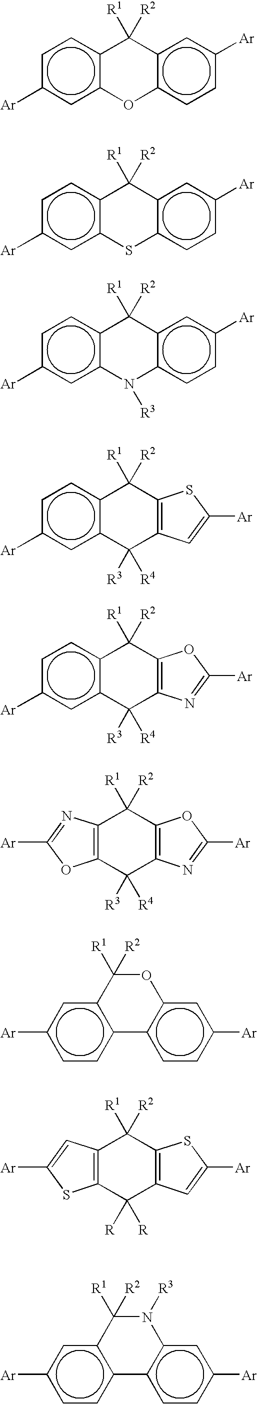 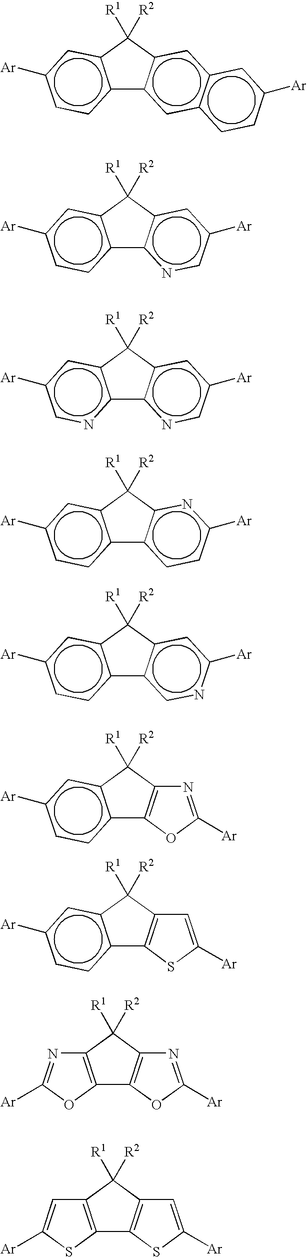 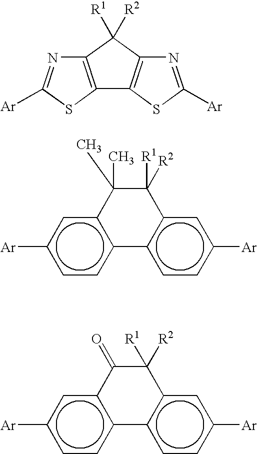
The molecular core units described above may be used as hosts or and may be used as charge transporting and light emitting materials in OLEDs as described in U.S. patent application Ser. Nos. 10/187,381 and 10/187,402.

Another advantage of using host-dopant compositions as emitters is that organometallic emitter materials may be used. These materials promote phosphorescence by means of spin-orbit coupling between transition metal atoms and the emissive chromophores in the emitter molecules. Such host-dopant compositions may be produced that have strong spin-orbit coupling while at the same time the phosphorescent emission is highly anisotropic and emanates from chromophores that are uniformly aligned by the liquid crystalline host phase. Exemplary organometallic molecular architectures are as follows:

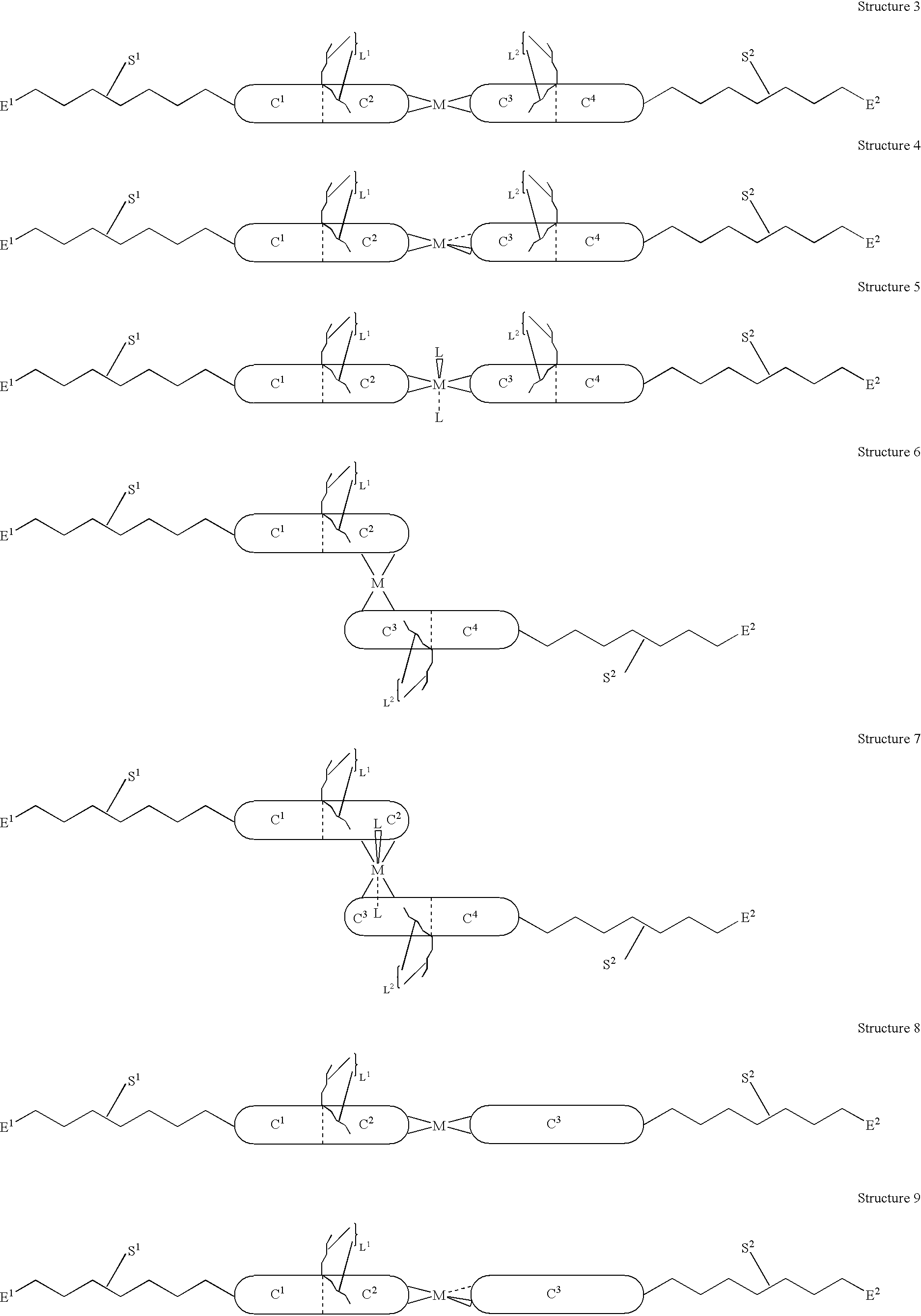

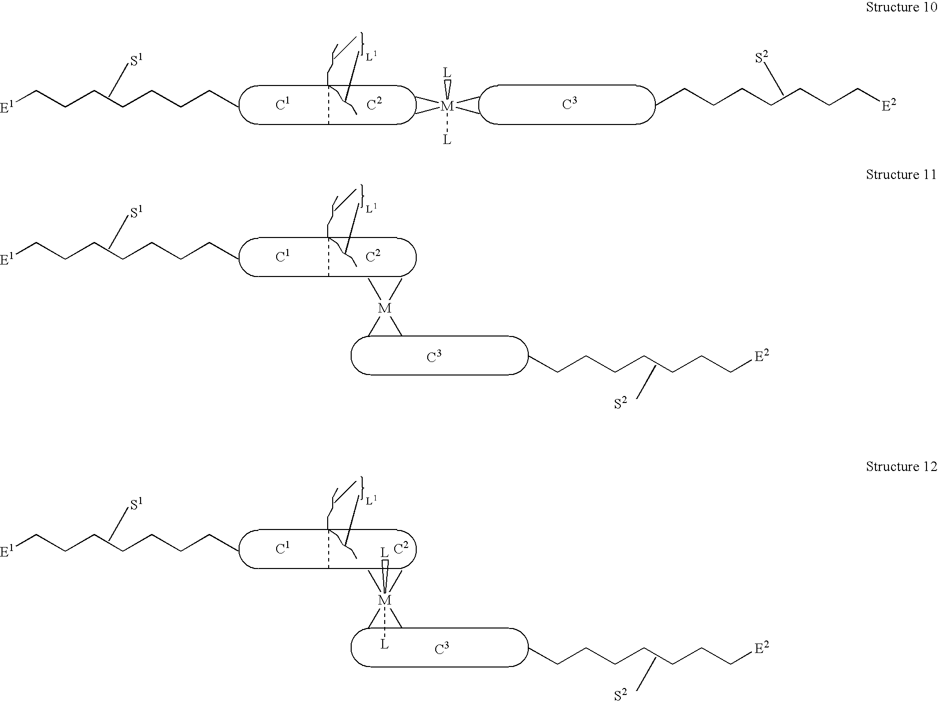

Structures 3, 6, 8, and 11 represent square planar metallocycles or complexes including two long, rod-shaped ligands covalently and/or coordinately bonded to a metal atom. Structures 4 and 9 represent tetrahedral metallocycles or complexes comprising two long, rod-shaped ligands covalently and/or coordinately bonded to a metal atom. Structures 5, 7, 10 and 12 represent octahedral metallocycles or complexes comprising two long, rod-shaped ligands covalently and/or coordinately bonded to a metal atom. L are monodentate ligands in these compounds. E, S, C, and L have the same meanings as in Structure 1. In structures 3 through 7 the two rod-shaped ligands may be identical (homoleptic) or different (heteroleptic). In structures 8 through 12 the ligands are by their nature heteroleptic.

In structures 3, 6, 8, and 11 the bonding of the ligands to the metal atom takes the general form: 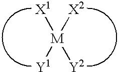
wherein:
M may be a bivalent metal such as Pt or Pd and one of X¹ and Y¹ and one of X² and Y² may be a carbon atom. Then the other two of X¹, Y¹, X², and Y² may be atoms with least one lone pair of electrons, for example, N, O, P, or S that are coordinately bonded to the metal. There are two possible configurations having this combination of atoms, one in which X¹ and X² are carbon atoms (the cis configuration) and one in which X¹ and Y² are carbon atoms (the trans configuration). An example of structure 3 with homoleptic substitution and the cis configuration is the following material:

### EXAMPLE 10

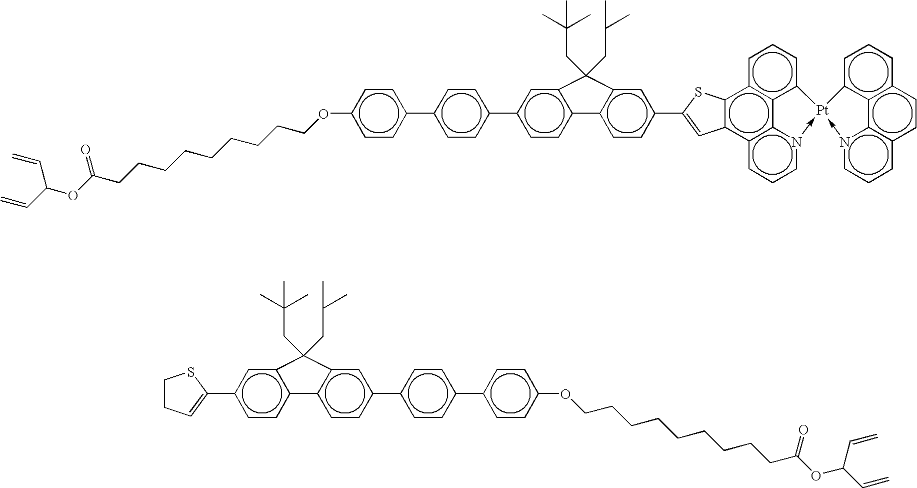

An example of structure 8 with heteroleptic substitution and the cis configuration is the following material:

### EXAMPLE 11

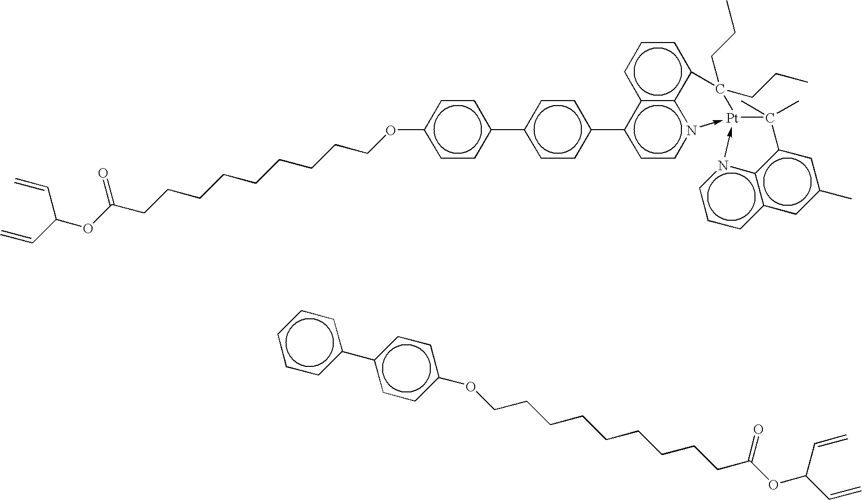

An example of structure 6 with homoleptic substitution and the trans configuration is the following material:

### EXAMPLE 12

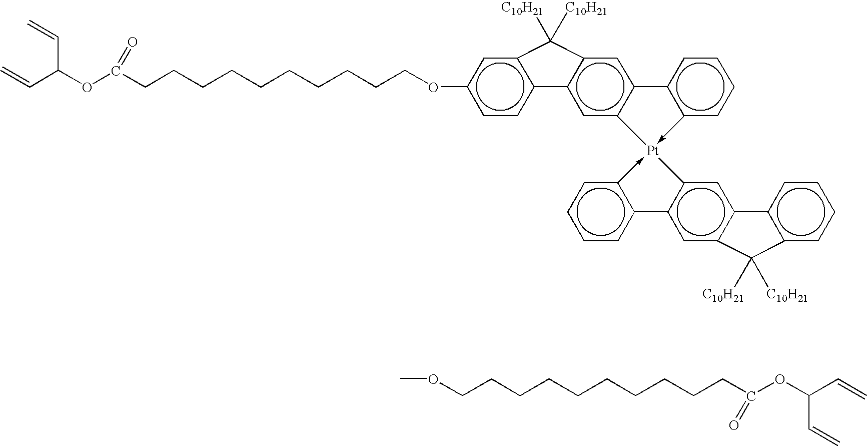

An example of structure 3 with homoleptic substitution and the trans configuration is the bis compound of a substituted di-α,α-propyl-di-N,N-methylbenzylamine with platinum as follows:

### EXAMPLE 13

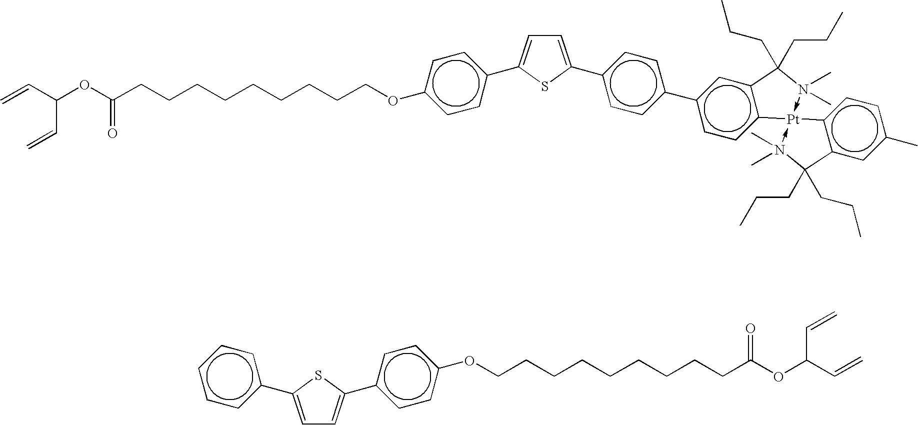

A synthesis for example 10 is as follows:

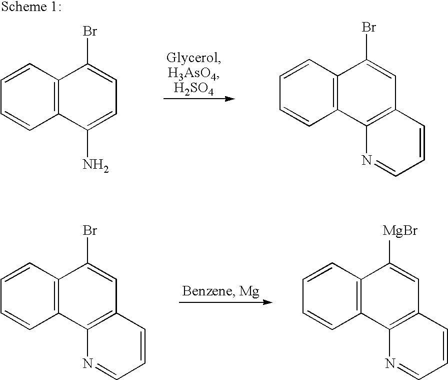

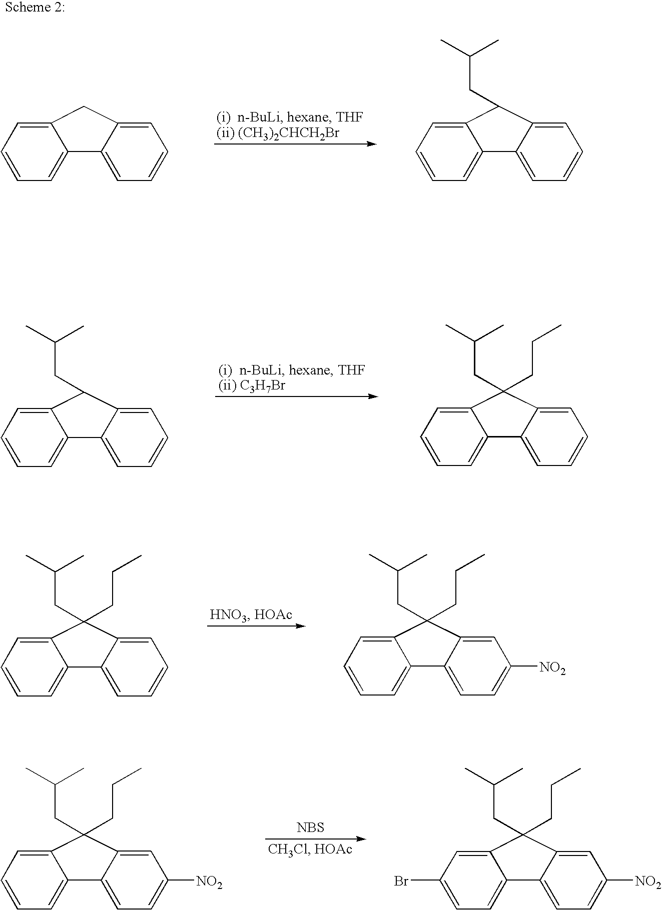

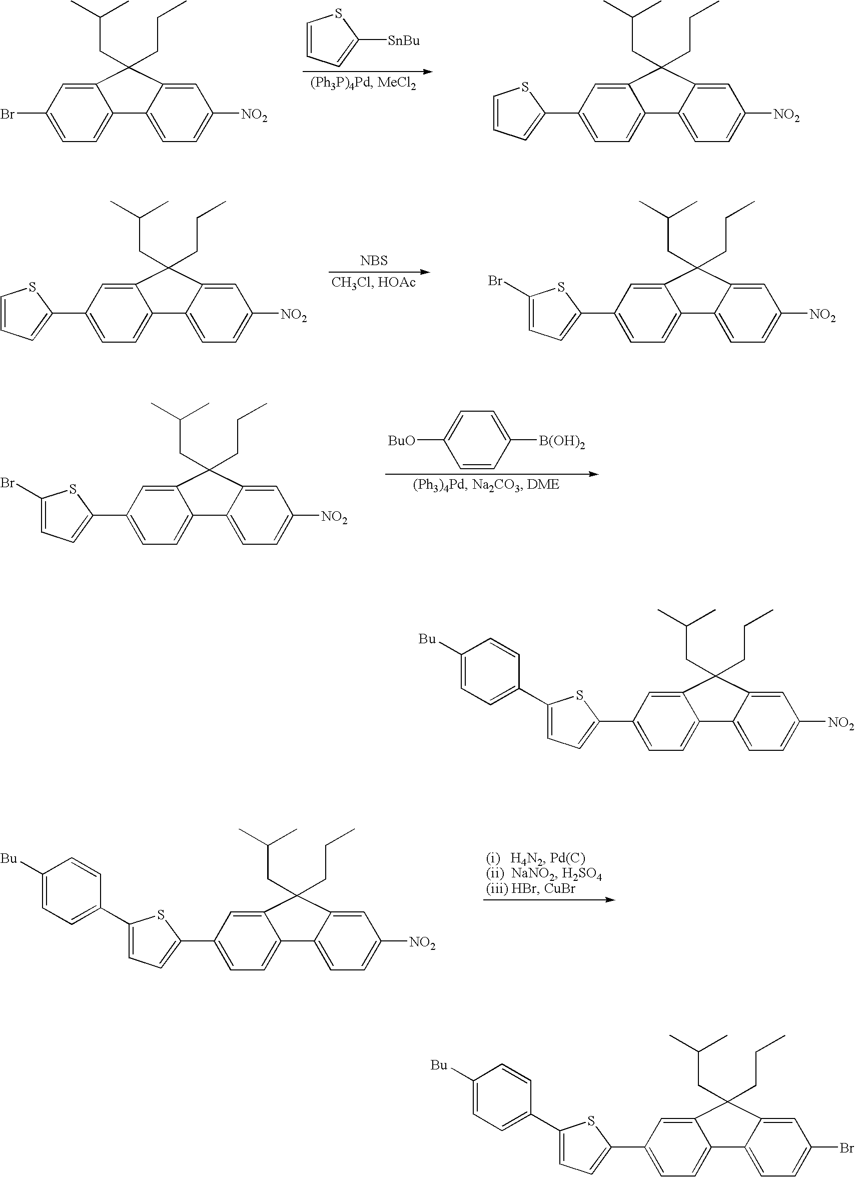

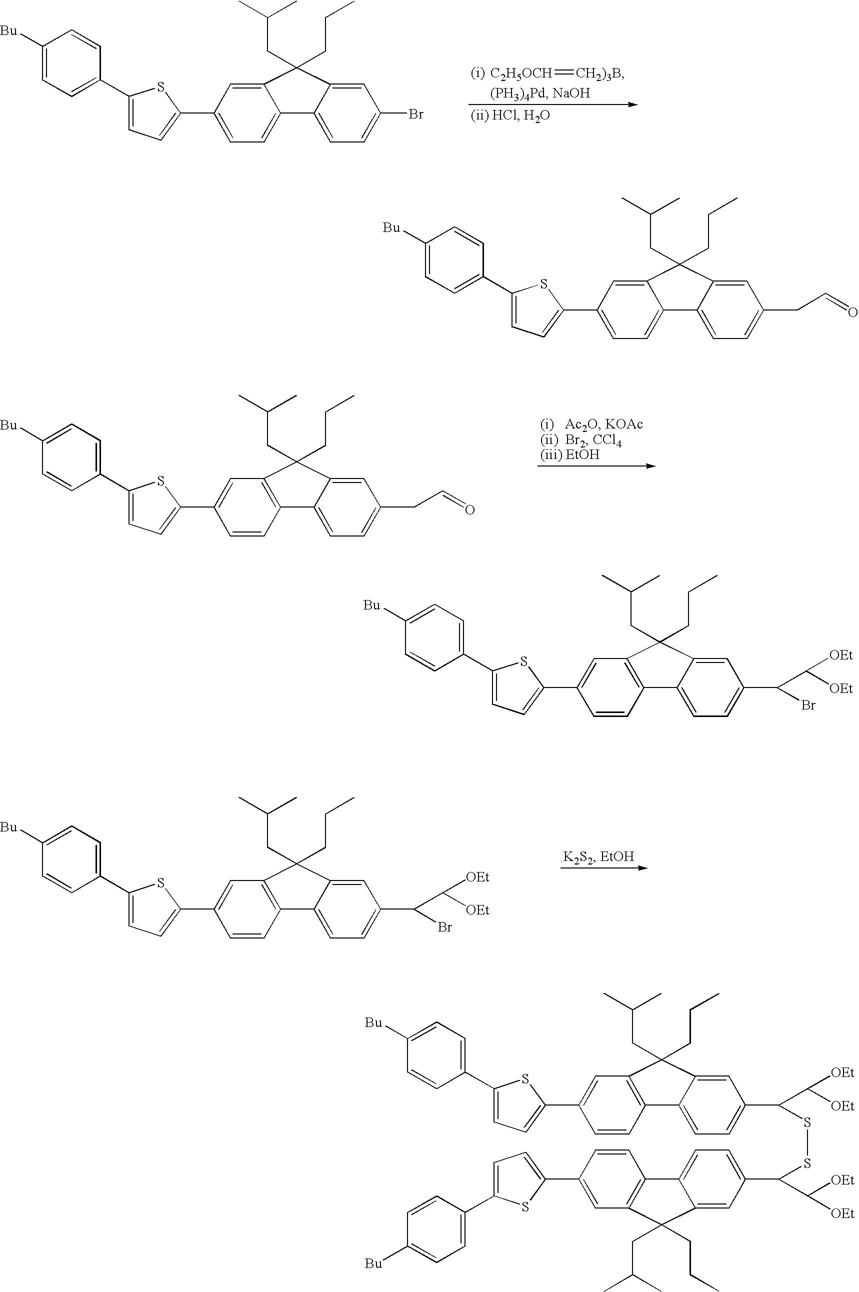

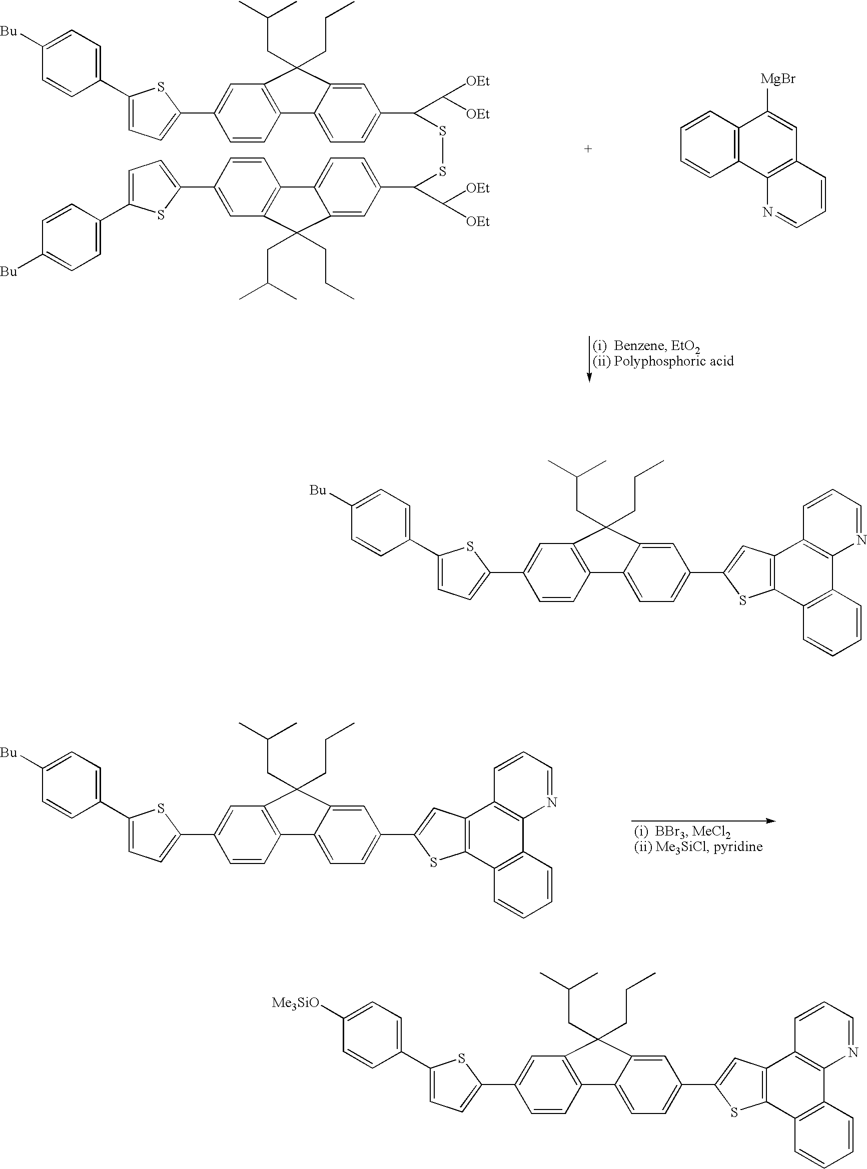

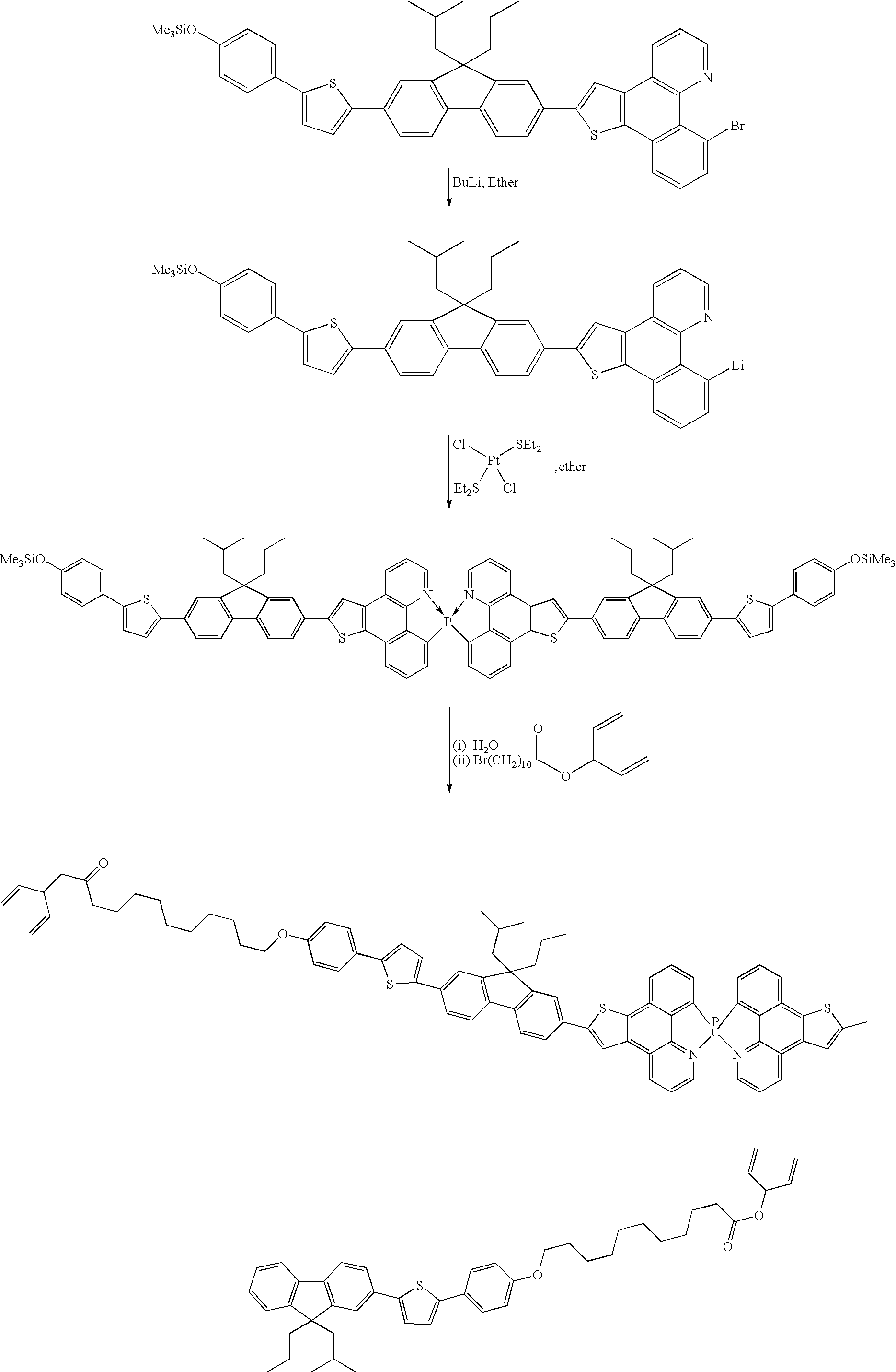

A synthesis for Example 12 is as follows: 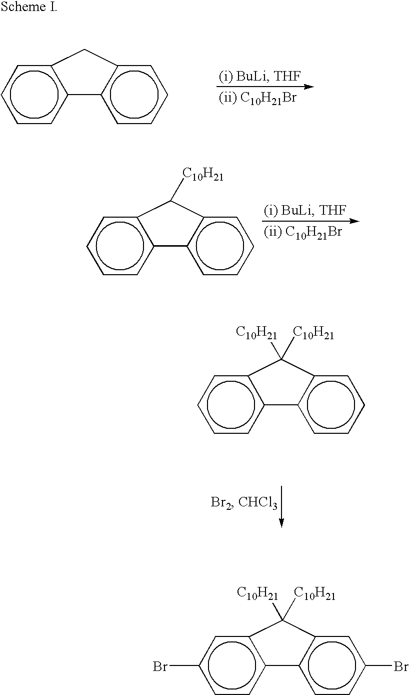 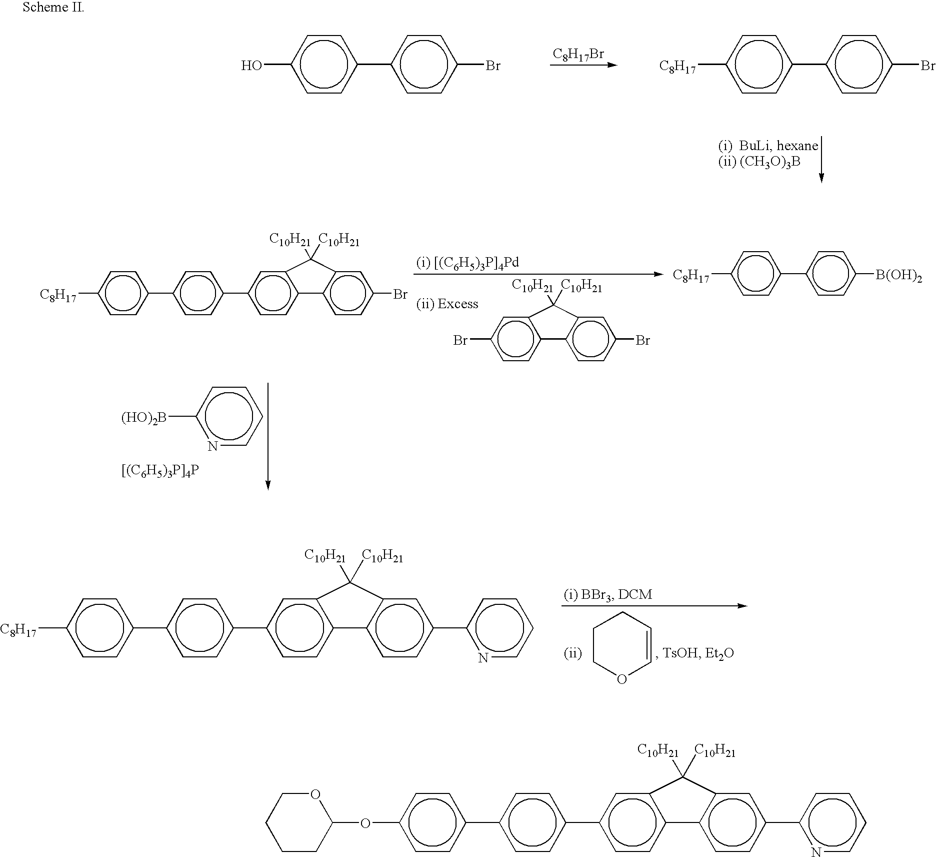 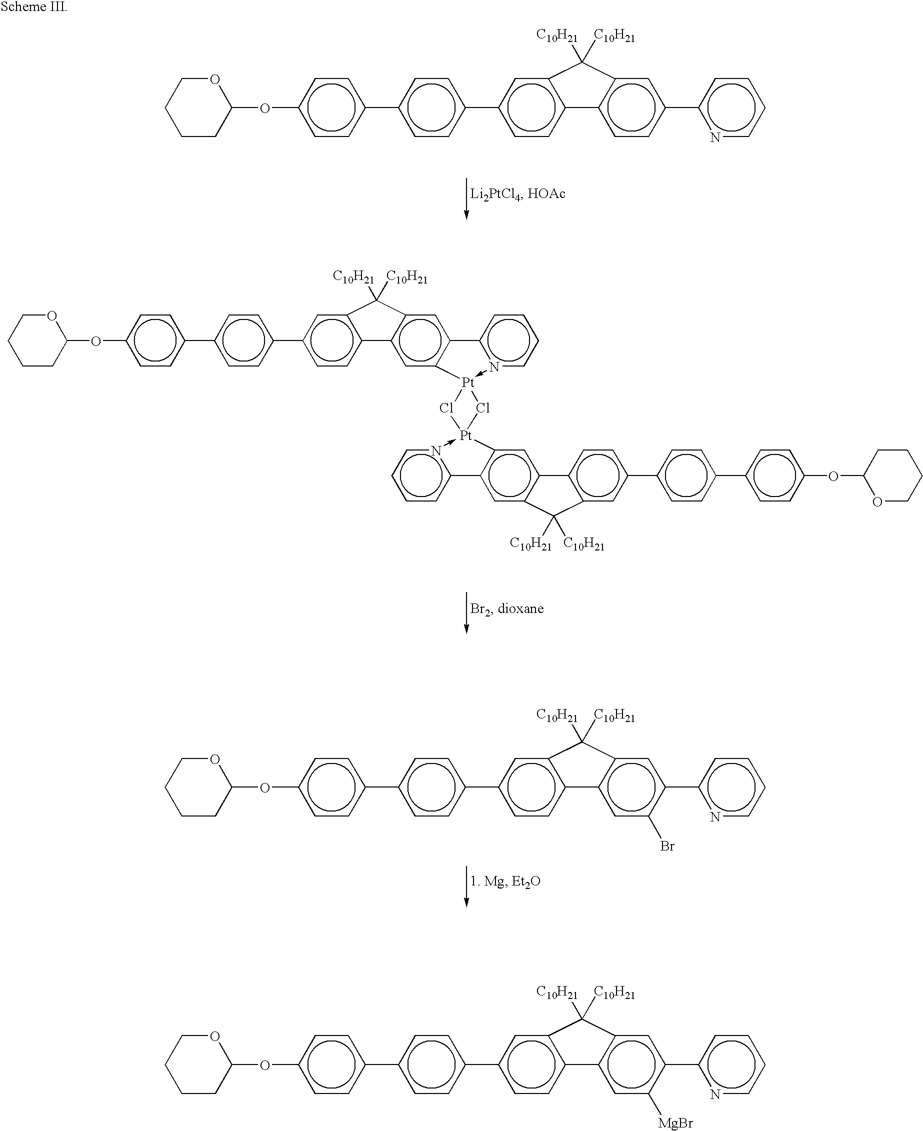 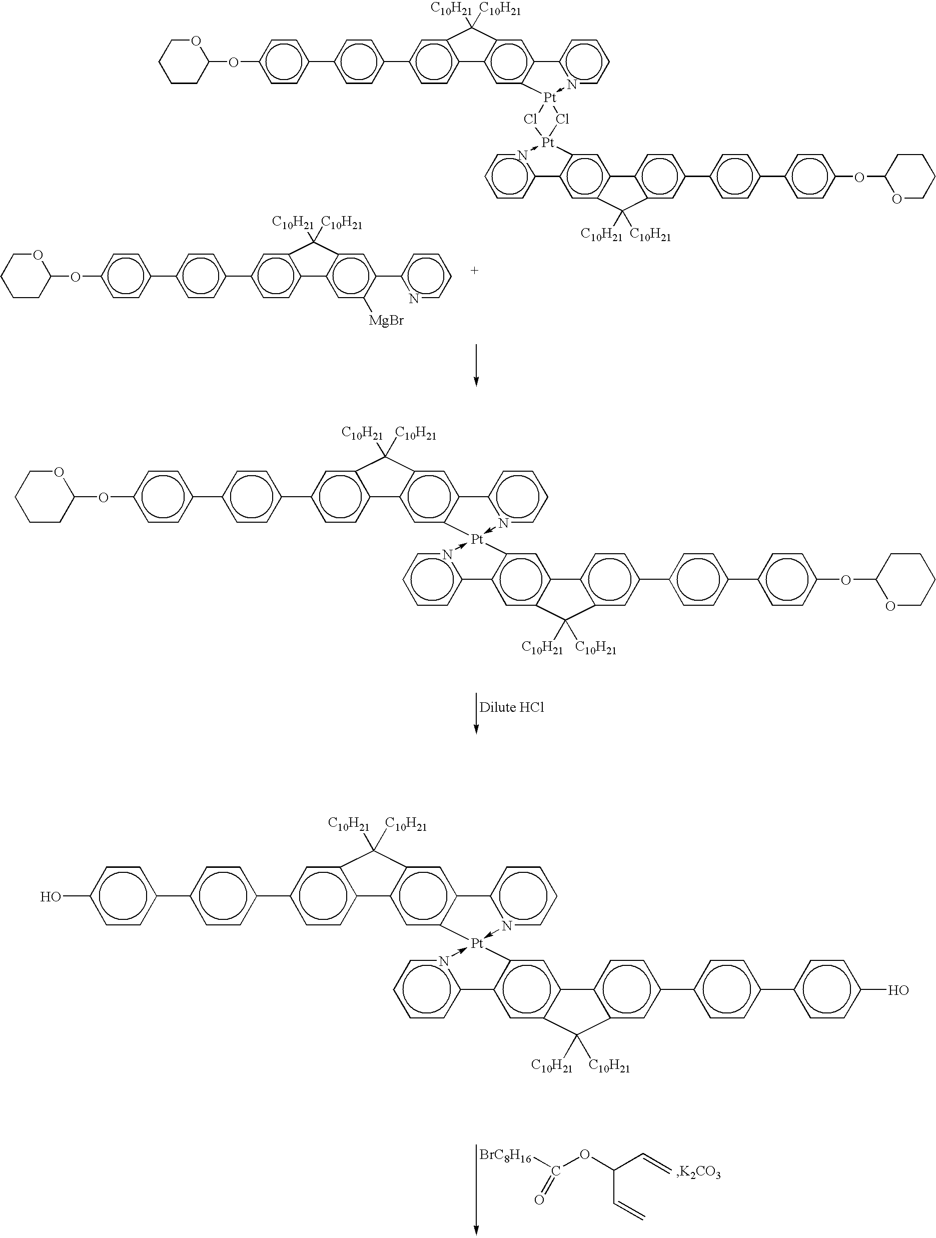 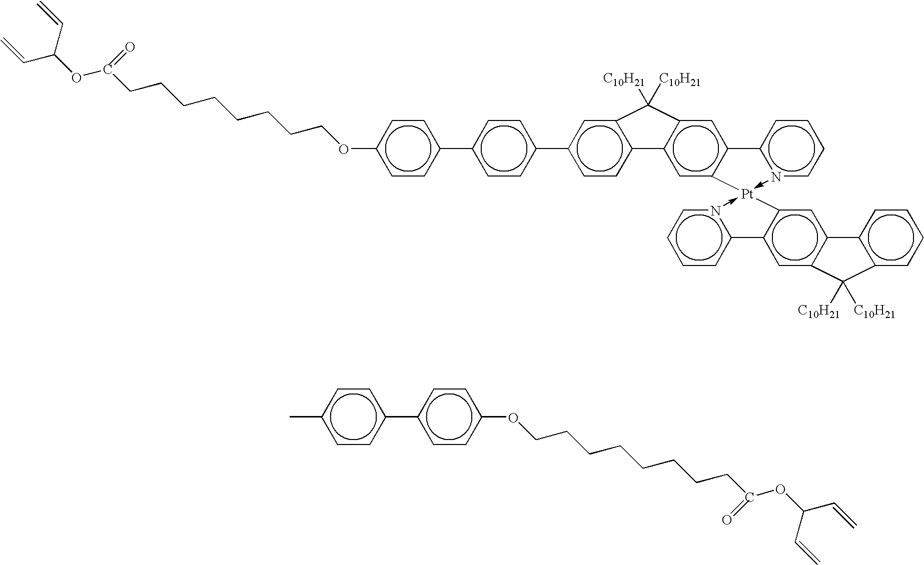
The dopants may be used to form host-dopant emitters. The host may have a liquid crystalline phase and may be aligned to emit polarized light. Where the host does not include a liquid crystalline phase, the dopant may nonetheless have a liquid crystalline phase. If the dopant with a liquid crystalline phase is aligned (e.g., the host has been or provides macroscopically ordered in some way—Langmuir Blodgett layers, stretching, liquid crystal on an alignment surface), the dopant will emit polarized light. Thus, aligned dopants having a liquid crystalline phase may be substituted for fluorescent dyes, laser dyes and other dyes and dopants such that a polarized emission is achieved.

The OLEDs discussed herein may be simple OLEDs, feedback enhanced OLEDs or lasing OLEDs. The emitted light of such OLED may be polarized or unpolarized.

Ar is an aromatic group or two more aromatic groups chained together in a substantially linear fashion and R¹, R², R³, and R⁴ may be flexible side chains selected from the group consisting of linear alkyl, branched alkyl, and alkenyl chains optionally including heteroatoms, carboxyl linkages and may optionally be terminated by a diene functional group chosen from amongst 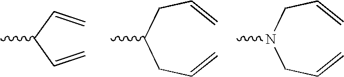
The chemical structure of GJR130, PV228 and MPA290 are as follows:

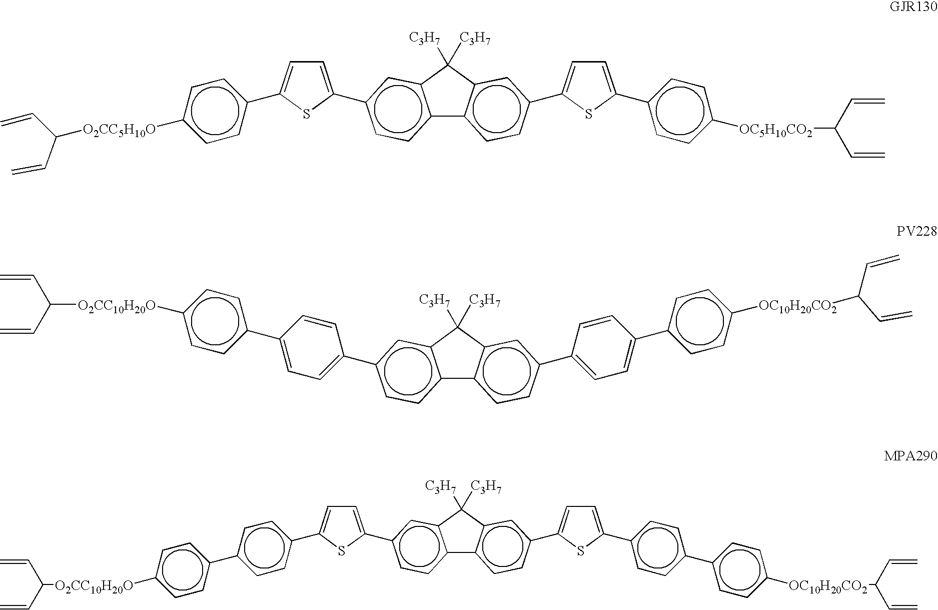

The excitation spectrum is the absorption spectrum that results in emission in the emission spectrum.

The molecules, compounds and the like disclosed herein may be used as hosts or dopants and may be used as charge transporting and light emitting materials in OLEDs as described in U.S. patent application Ser. Nos. 10/187,381 and 10/187,402.

The compounds and mixtures of the present invention provide a number of advantageous. The compounds and mixtures may be made as room-temperature nematics that may be easily photocrosslinked with a high final degree of polymerization. The layers of crosslinked layers material may be incorporated into electronic devices. In the case of the charge transporting and luminescent molecules diene crosslinking functional groups, since no initiator is used and since mixtures may be used to form the layers, the resultant device operating lifetimes are uncompromised by the polymerization process.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

1. A compound comprising:
an emissive dopant,
wherein the emissive dopant has a liquid crystalline phase.

2. The compound of claim 1, wherein the liquid crystalline phase is a nematic phase.

3. (canceled)

4. The compound of claim 1, wherein the emissive dopant is photopolymerizable.

5. The compound of claim 1, wherein the emissive dopant is aligned.

6. The compound of claim 1, wherein the emissive dopant emits polarized light.

7-15. (canceled)

16. An emissive layer comprising:
a host doped with an emissive dopant,
wherein the emissive dopant has a liquid crystalline phase.

17. The layer of claim 16, wherein the host is a charge transporting organic material.

18. The layer of claim 16, wherein the dopant has molecules that are rod or lathe-shaped.

19. The layer of claim 16, wherein the host has a liquid crystalline phase.

20. The layer of claim 16, wherein the host is polymerizable.

21-24. (canceled)

25. The layer of claim 16, wherein the emissive dopant is an aligned emissive dopant.

26. The layer of claim 25, wherein the emissive dopant emits polarized light.

27. (canceled)

28. The layer of claim 16,
wherein the host has an emission spectrum that substantially overlaps the excitation spectrum of the emissive dopant; and
wherein the host has an absorption spectrum that does not substantially overlap the emission spectrum of the emissive dopant.

29-32. (canceled)

33. The layer of claim 16, wherein the host is a photopolymerizable material.

34. (canceled)

35. The layer of claim 33, wherein the host incorporates diene crosslinking functional groups.

36. (canceled)

37. The layer of claim 16, wherein the emissive dopant is a polymerizable material.

38. The layer of claim 16, wherein the emissive dopant is a photopolymerizable material.

39. (canceled)

40. The layer of claim 33, wherein the emissive dopant incorporates diene crosslinking functional groups.

41. The layer of claim 16, wherein the emissive dopant and the host are crosslinked to each other.

42. The layer of claim 16, wherein the emissive dopant is phosphorescent.

43-55. (canceled)

56. A charge transporting or light emitting compound comprising:
a molecule having the formula:
E-S-C-L-C-S-E
wherein E is a reactive molecular end group that is capable of being crosslinked, S is a flexible spacer; C is a chromophoric unit that absorbs electrical, photon, or chemical energy promoting the molecule into an excited electronic state, L is a structure or structures that extend laterally from the otherwise lathe-shaped compound,
wherein C-L-C is not fluorene.

57. (canceled)

58. The molecule of claim 56, wherein the C-L-C is a dihydroacene of the general formula: 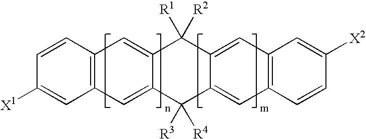
where n and m may independently vary from 0 to 5, X¹ and X² independently are one or more aryl groups chained together in a substantially linear fashion, and R¹, R², R³, and R⁴ are flexible side chains selected from the group consisting of linear alkyl, branched alkyl, and alkenyl chains.

59-64. (canceled)

65. The compound of claim 56, wherein the compound has a liquid crystalline phase.

66. (canceled)

67. The compound of claim 56, wherein the compound is photopolymerizable.

68. The compound of claim 56, wherein the compound is aligned.

69. The compound of claim 68, wherein the compound emits polarized light.

70-93. (canceled)

94. An organometallic emitter molecule comprising:
an emitter molecule having the formula selected from one of: 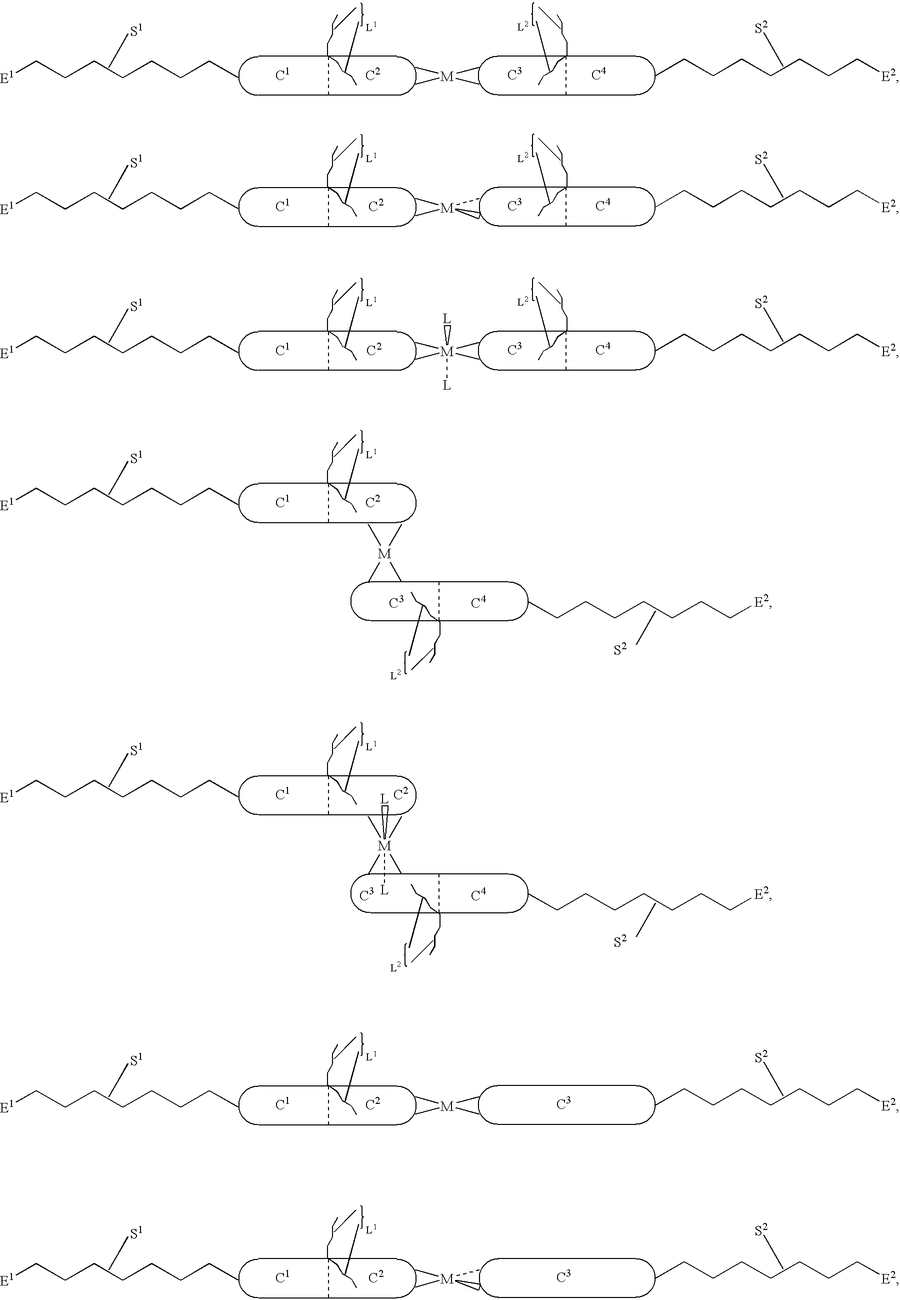 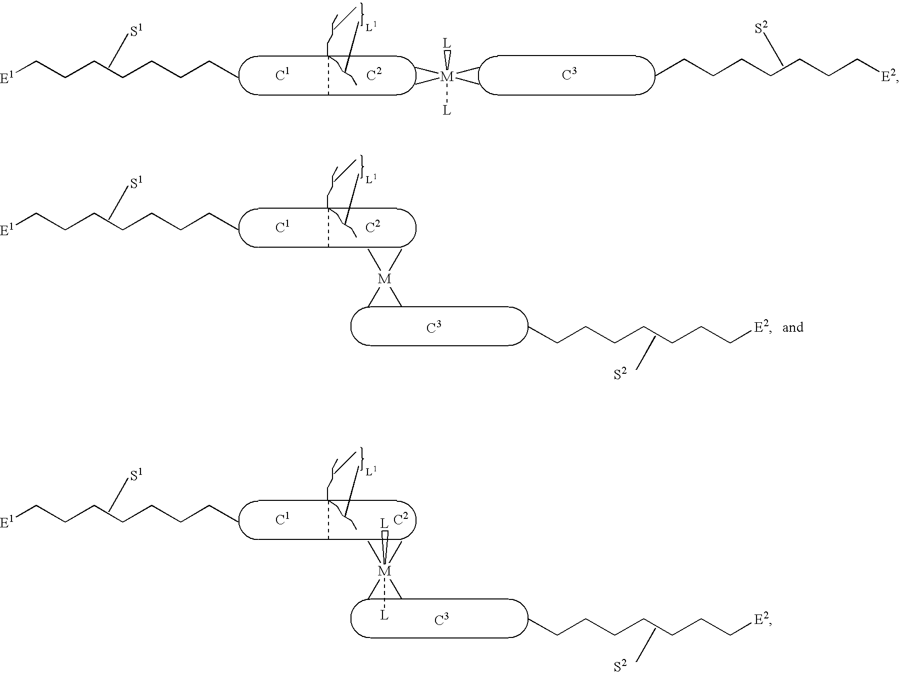
wherein E¹, E² are reactive molecular end groups that are capable of being crosslinked, S¹ and S² are flexible spacers; C¹, C², C³ and C⁴ are chromophoric units that absorbs electrical, photon, or chemical energy and then reradiates the electrical, photon, or chemical energy as light or laser dyes, L¹, L², L³, L⁴ is a structure or structures that extend laterally from the otherwise lathe-shaped compound, L is monodentate ligand and M is a metal atom.

95. The molecule of claim 94, wherein the C², C³ and the metal have the general formula: 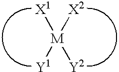
wherein:
M is a bivalent metal,
one of X¹ and Y¹ and one of X² and Y² is a carbon atom and the other two of X¹, Y¹, X², and Y² are atoms with least one lone pair of electrons.

96-142. (canceled)

143. A charge transporting or light emitting compound comprising:
a molecule having the formula:
E-S-CLC-S-E
wherein E is a reactive molecular end group that is capable of being crosslinked,
wherein S is a flexible spacer; and
wherein the CLC is a molecular core of the general formula: 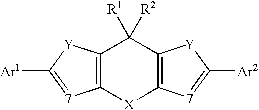
wherein X is chosen from O, NR³, CR³R⁴, S, PR³, SiR³R⁴, and carbonyl, where R³ and R⁴ are independently chosen from H, linear alky chains, branched alkyl chains and alkenyl chains;
wherein R¹ and R² are flexible side chains chosen from the group consisting of linear alkyl, branched alkyl and alkenyl chains;
wherein Y¹ and Y² are independently chosen from O, S, and NH;
wherein Z¹ and Z² are independently chosen from CH and N; and
wherein Ar¹ and Ar² independently are one or more aryl groups chained together in a substantially linear fashion.

144-148. (canceled)

149. A charge transporting or light emitting compound comprising:
a molecule having the formula:
E-S-CLC-S-E
wherein E is a reactive molecular end group that is capable of being crosslinked;
wherein S is a flexible spacer; and
wherein the CLC is a molecular core of the general formula: 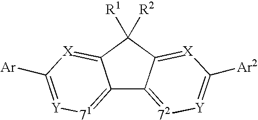
wherein five of X¹, Y¹, Z¹, X², Y², and Z² are independently chosen from N and CH provided the sixth of X¹, Y¹, Z¹, X², Y², and Z² is CH;
wherein R¹ and R² are flexible side chains chosen from the group consisting of linear alkyl, branched alkyl and alkenyl chains; and
wherein Ar¹ and Ar² independently are one or more aryl groups chained together in a substantially linear fashion.

150-166. (canceled)
